(19) United States
(12) Patent Application Publication
(10) Pub. No.: US 2026/0187547 A1
(43) Pub. Date: Jul. 2, 2026

(54) IMPLEMENTING MACHINE-LEARNED MODELS TO OBTAIN A MEASUREMENT VALUE OUTPUT BY A MEASUREMENT DEVICE

(71) Applicant: Fluke Corporation, Everett, WA (US)

(72) Inventors: Darshankumar Hosamani, Karnataka (IN); Madhusudhana Konda Nageshbabu, Mill Creek, WA (US); Shreyank Karjigi, Karnataka (IN); Souleymane Dembele, Olympia, WA (US); Thejasvi KS, Karnataka (IN)

(21) Appl. No.: 19/431,923

(22) Filed: Dec. 23, 2025

Related U.S. Application Data
(60) Provisional application No. 63/739,374, filed on Dec. 27, 2024.

(51) Int. Cl. G06N 20/20; G06T 7/73; G06V 30/10

(52) U.S. Cl. CPC G06N 20/20; G06T 7/73; G06V 30/10

(57) ABSTRACT

A method for calibrating a measurement device based on images depicting a measurement output value associated with the measurement device includes: obtaining an image depicting a measurement device; implementing one or more first machine-learned models to determine whether the measurement device depicted in the image is a first type of measurement device or a second type of measurement device; when the measurement device is determined to be the first type of measurement device, implementing one or more second machine-learned models to obtain a measurement value output by the measurement device; when the measurement device is determined to be the second type of measurement device, implementing one or more third machine-learned models to obtain the measurement value output by the measurement device; and providing the measurement value output by the measurement device obtained via the one or more second machine-learned models or the one or more third machine-learned models.

### CROSS-REFERENCE TO RELATED APPLICATIONS

This application claims priority to and the benefit of U.S. Provisional Application No. 63/739,374 filed on Dec. 27, 2024, the contents of which are incorporated by reference herein in its entirety for all purposes.

### FIELD

The disclosure relates generally to image analysis. More particularly, the disclosure relates to analyzing images using machine-learned models and other forms of artificial intelligence to take a reading from a measurement device.

### BACKGROUND

Methods exist for capturing an image of a monitoring meter and using a neural network model to calculate monitoring data corresponding to the image. However, the output of the monitoring data may be incorrect or may not have metrology grade measurement accuracy or reliability needed for certain fields and environments such as calibration facilities, laboratories, quality control environments, etc.

### SUMMARY

Aspects and advantages of embodiments of the disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Example aspects of the disclosure include a computer-implemented method to calibrate a measurement device based on images depicting a measurement output value associated with the measurement device. The computer-implemented method includes obtaining, by a computing device comprising one or more processors, an image depicting a measurement device; implementing, by the computing device, one or more first machine-learned models to determine whether the measurement device depicted in the image is a first type of measurement device or a second type of measurement device; when the measurement device is determined to be the first type of measurement device, implementing, by the computing device, one or more second machine-learned models to obtain a measurement value output by the measurement device; when the measurement device is determined to be the second type of measurement device, implementing, by the computing device, one or more third machine-learned models to obtain the measurement value output by the measurement device; and providing, by the computing device, the measurement value output by the measurement device obtained via the one or more second machine-learned models or the one or more third machine-learned models.

Example aspects of the disclosure include a computing device comprising one or more memories configured to store instructions; and one or more processors configured to execute the instructions to perform operations. The operations can include: obtaining an image depicting a measurement device; implementing one or more first machine-learned models to determine whether the measurement device depicted in the image is a first type of measurement device or a second type of measurement device; when the measurement device is determined to be the first type of measurement device, implementing one or more second machine-learned models to obtain a measurement value output by the measurement device; when the measurement device is determined to be the second type of measurement device, implementing one or more third machine-learned models to obtain the measurement value output by the measurement device; and providing the measurement value output by the measurement device obtained via the one or more second machine-learned models or the one or more third machine-learned models.

The computing device may be configured to execute instructions to perform operations associated with any of the other aspects and operations of the computer-implemented methods described herein.

Example aspects of the disclosure include a non-transitory computer readable medium storing instructions which, when executed by a processor, cause the processor to perform operations for calibrating a measurement device, the operations comprising: obtaining an image depicting a measurement device; implementing one or more first machine-learned models to determine whether the measurement device depicted in the image is a first type of measurement device or a second type of measurement device; when the measurement device is determined to be the first type of measurement device, implementing one or more second machine-learned models to obtain a measurement value output by the measurement device; when the measurement device is determined to be the second type of measurement device, implementing one or more third machine-learned models to obtain the measurement value output by the measurement device; and providing the measurement value output by the measurement device obtained via the one or more second machine-learned models or the one or more third machine-learned models.

The non-transitory computer-readable medium may store additional instructions to execute any of the other aspects and operations of the computing devices, computing systems, and computer-implemented methods described herein.

Other example aspects of the disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the disclosure and, together with the description, help explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system, according to example embodiments of the disclosure.

FIG. 1B depicts a block diagram of an example computing system including a measurement application, according to example embodiments of the disclosure.

FIGS. 2A through 2B are example computer-implemented methods for reading an output value of a measurement device for a calibration process, according to example embodiments of the disclosure.

FIG. 3 is an example training image, according to an example embodiment of the disclosure.

FIGS. 4A through 4B are example user interface screens for reading an output value of a measurement device for a calibration process, according to example embodiments of the disclosure.

FIGS. 5A through 5D are example user interface screens for reading an output value of a measurement device for a calibration process, according to example embodiments of the disclosure.

FIGS. 6A through 6C are example user interface screens for reading an output value of a measurement device for a calibration process, according to example embodiments of the disclosure.

FIGS. 7A-7C depict portions of a prompt which can be provided to a machine-learned model for reading an output value of a measurement device for a calibration process, according to example embodiments of the disclosure.

FIG. 8 is a flow chart diagram illustrating an example method for training a machine-learned model, according to example embodiments of the disclosure.

FIG. 9 is a block diagram of an example sequence processing model, according to example embodiments of the disclosure.

FIG. 10 is a block diagram of an example implementation of a multi-modal sequence processing model, according to example embodiments of the disclosure.

FIG. 11 is an example training flow for training a machine-learned model, according to example embodiments of the disclosure.

FIG. 12 is a block diagram of an example networked computing system, according to example embodiments of the disclosure.

Reference numerals that are repeated across plural figures are intended to identify the same features in various implementations.

### DETAILED DESCRIPTION

### Overview

In the fields of industrial maintenance, building inspection, electrical/mechanical maintenance, etc., accurate measurements are needed to ensure systems operate safely and in compliance with rules, regulations, etc. Calibrated measurement devices (tools) are devices that have been measured and adjusted against a known value to ensure accuracy and consistency of their readings. In order to calibrate measurement devices, the process can involve comparing the measurement readings of the tool to a reference standard of known accuracy. The measurement devices under test can then be adjusted to ensure they are providing accurate measurements within a specified range. Measurement devices may need to be regularly calibrated so they can continue to provide accurate measurements.

Following a manual calibration process in which an operator manually takes measurements can be cumbersome, consume a large amount of time, and be subject to error. Automating the calibration process can ensure that the process is performed exactly the same way every time, no matter the operator or location. This can improve the quality of results, reduce error, and standardize calibration methods.

A calibration system can include a process or set of procedures that ensures the accuracy and reliability of measurement or testing devices over time. A calibration system can include capture devices (e.g., cameras) that capture images of outputs (measurement results or readings) of metering devices which can include analog metering devices (gauges) and/or digital metering devices (gauges). The calibration system can include a measurement application (e.g., a calibration application) that processes the images captured by the capture device to determine the output of the measurement device. The measurement application can determine whether the measurement device is operating within parameters and is properly calibrated so that the measurement device can continue to provide accurate measurements.

According to the methods and computing systems of the disclosure described herein, computer vision approaches are applied to automate the calibration process. For example, the calibration process can be applied to electrical, mechanical, or industrial equipment or systems having various types of gauges. The methods and computing systems of the disclosure described herein provide information so that measurement devices can be calibrated as needed, according to a predefined schedule, etc., to ensure that the measurement devices remain in service and are operating safely and within defined parameters. The methods and computing systems of the disclosure described herein provide information so that the computing systems and associated users can readily identify and focus on measurement devices which may need re-calibration, replacement, maintenance or repair, or other types of intervention procedures, when an output indicates a measurement device is not operating within defined parameters.

The application of computer vision techniques to calibration processes can be technically challenging for measurement devices which must meet metrology-grade standards for use in certain environments (e.g., laboratories, calibration facilities, quality control environments, etc.) where precise measurements are needed. Therefore, a technical problem in the field of image analysis and computer vision is the application of computer systems to automatically analyze images of measurement devices (e.g., for electrical, mechanical, or industrial equipment or systems) to obtain a metrology-grade measurement that can be used to calibrate the measurement device. For example, during calibration, internationally accepted standards of known accuracy may be used to check the output values of measurement devices to ensure their proper operation. Examples of equipment that can be calibrated can include welders, hand tools, gauges, calipers, thermometers, odometers, hardness testers, heating and cooling equipment, optical devices, etc. The computing systems described herein can obtain accurate measurements associated with properties including pressure, torque, humidity, flow, temperature, mass, etc., for all types of measurement devices and can evaluate measurements with a specified measurement accuracy (e.g., within 1%, within 0.1%, etc., of the actual value) against a measurement standard.

An example technical solution implemented by the methods and computing systems of the disclosure described herein can include an integrated system that uses machine-learned models and object detection or classification algorithms to identify different types of measurement devices which are depicted in images and to determine a measurement output value which is output by the measurement device. In some implementations, the machine-learned models can be trained in a manner to be device agnostic such that the measurement output value can be determined via the machine-learned models regardless of a type of measurement device (e.g., a thermometer, caliper, pressure gauge, etc.) depicted in the image. Therefore, less computing resources (e.g., less memory, fewer models) can be expended for determining measurement output values. Further, the generalized machine-learned model can be updated in a more efficient manner than developing and maintaining multiple specialized models.

In some implementations, the machine-learned models can include fine-tuned machine-learned models that are implemented for specific tasks with respect to specific or particular measurement devices. Utilizing specialized models for particular measurement devices may use less computing resources (e.g., each model can be based on less training data and be smaller in size, using few parameters) and may provide faster and more accurate inferences which allow for specialized feature extraction and tuning.

The methods and computing systems of the disclosure described herein can offer significant value to users by saving time and reducing the need for manual analysis. With the automated detection and determination of measurement output values of a measurement device, the methods and computing systems of the disclosure described herein can quickly and accurately calibrate the measurement device. Further, measurement devices which do not satisfy calibration requirements can be quickly identified and appropriate actions can be taken (e.g., taking the measurement device out of service, repairing the measurement device, replacing the measurement device, etc.).

The methods and computing systems of the disclosure described herein provide flexibility through the implementation of a user interface, enabling users to enter or adjust measurement values in the case that the measurement values determined via the machine-learned models are inaccurate, enabling users to provide feedback regarding the accuracy of the measurement values determined via the machine-learned models, and enabling users to monitor a calibration process through a series of measurements that are automatically read via the machine-learned models described herein. The feedback provided by the user can also be used to retrain and improve the machine-learned models.

With reference now to the drawings, example embodiments of the disclosure will be discussed in further detail.

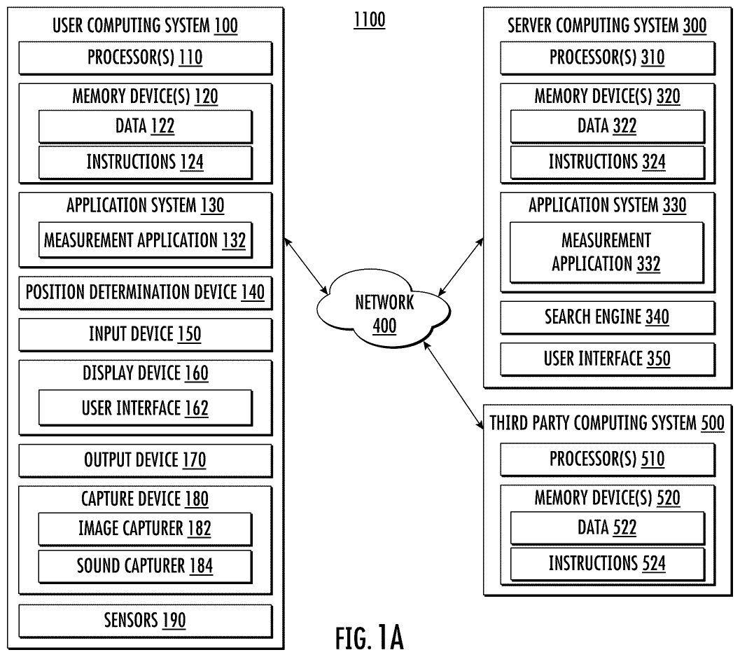

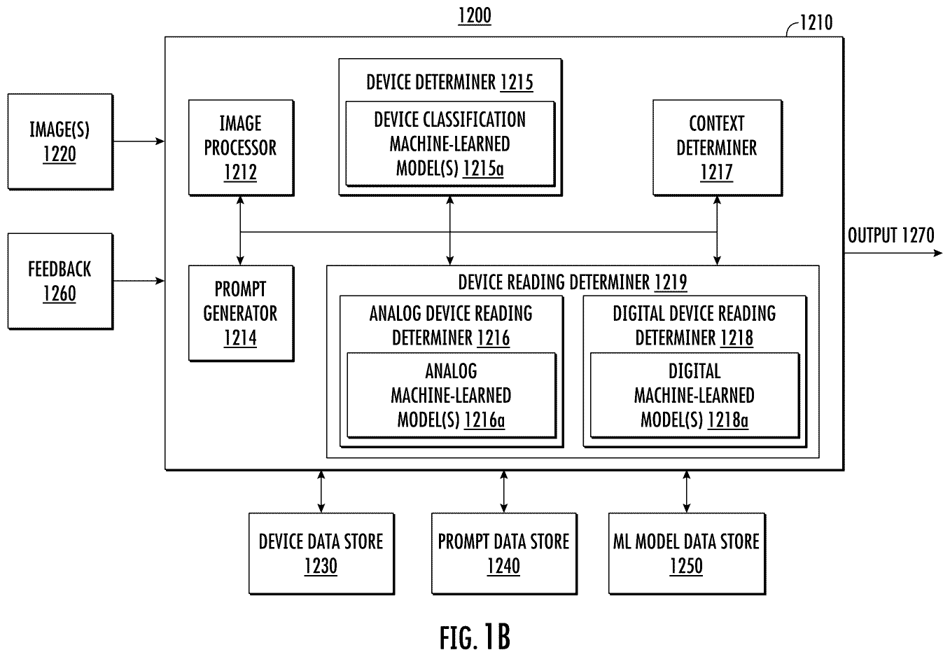

FIG. 1A depicts a block diagram of an example computing system 1100 according to example embodiments of the disclosure. The computing system 1100 includes a user computing system 100, a server computing system 300, and/or a third party computing system 500 that are communicatively coupled over a network 400.

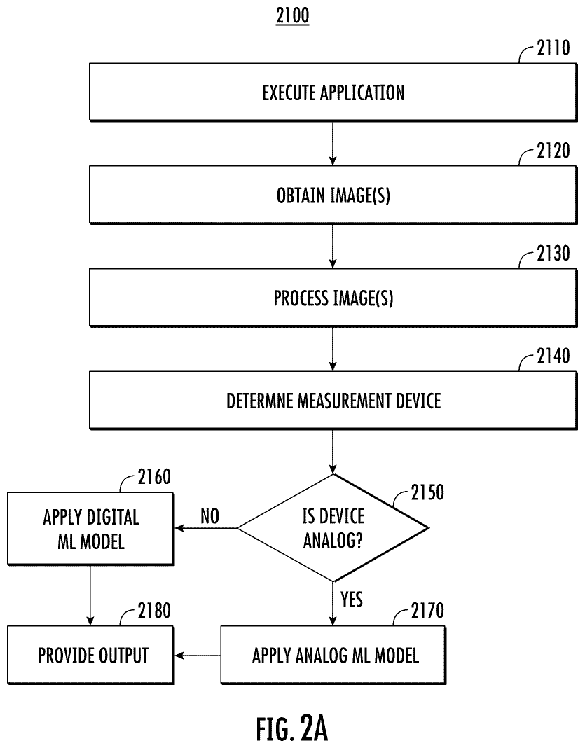

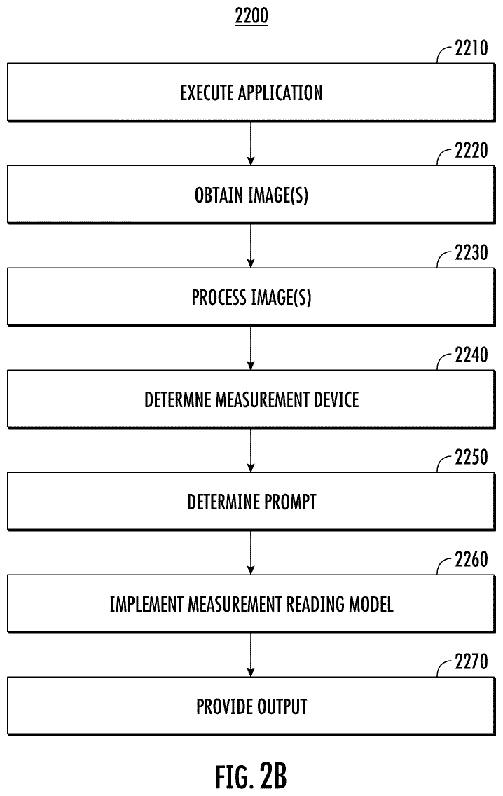

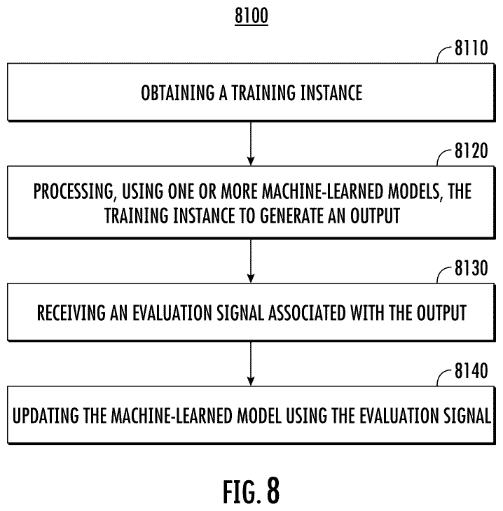

The user computing system 100 can include any type of computing device, such as, for example, a personal computing device (e.g., laptop or desktop), a mobile computing device (e.g., smartphone or tablet), a gaming console or controller, a wearable computing device (e.g., augmented-reality goggles), an embedded computing device, or any other type of computing device. In some implementations, the user computing system 100 can be realized by a single computing device or can be realized by a plurality of computing devices. For example, the user computing system 100 can include a first computing device (e.g., a smartphone, wearable computing device, etc.) to capture images of a measurement device and a second computing device (e.g., a laptop computer, a desktop computer, etc.) to receive the images and to analyze the images. For example, the user computing system 100 can correspond to and implement some or all of the operations implemented by computing system 1200 described herein with respect to FIG. 1B and some or all of the operations of the computer-implemented methods described herein (e.g., the computer-implemented methods of FIGS. 2A-2B and FIG. 8).

The server computing system 300 can include or otherwise be implemented by one or more server computing devices. In instances in which the server computing system 300 includes plural server computing devices, such server computing devices can operate according to sequential computing architectures, parallel computing architectures, or some combination thereof. For example, the server computing system 300 can correspond to and implement some or all of the operations implemented by computing system 1200 described herein with respect to FIG. 1B and some or all of the operations of the computer-implemented methods described herein (e.g., the computer-implemented methods of FIGS. 2A-2B and FIG. 8).

The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the user computing system 100, server computing system 300, and/or third party computing system 500 may form part of an application system which can provide a tool via one or more machine-learned models for users to perform a calibration process with respect to a measurement device for a piece of equipment or system (e.g., an electrical system, mechanical system, etc.).

The user computing system 100 includes one or more processors 110, one or more memory devices 120, an application system 130, a position determination device 140, an input device 150, a display device 160, an output device 170, a capture device 180, and one or more sensors 190. The server computing system 300 may include one or more processors 310, one or more memory devices 320, an application system 330, a search engine 340, and a user interface 350. The third party computing system 500 may include one or more processors 510 and one or more memory devices 520.

For example, the one or more processors 110, 310, 510 can be any suitable processing device that can be included in a user computing system 100, server computing system 300, or third party computing system 500. For example, the one or more processors 110, 310, 510 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310, 510 can be a single processor or a plurality of processors that are operatively connected, for example in parallel.

The one or more memory devices 120, 320, 520 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a Blu-ray disk, or optical media such as CD ROM discs and DVDs, and combinations thereof. However, examples of the one or more memory devices 120, 320, 520 are not limited to the above description, and the one or more memory devices 120, 320, 520 may be realized by other various devices and structures as would be understood by those skilled in the art.

The one or more memory devices 120, 320, 520 can store data 122, 322, 522 and instructions 124, 324, 524 which are executed by the one or more processors 110, 310, 510 to cause the user computing system 100, server computing system 300, and third party computing system 500 to perform operations (e.g., operations associated with the methods described herein).

In some example embodiments, the user computing system 100 includes an application system 130. For example, the application system 130 may include a measurement application, a calibration application, an image analysis application, or combinations thereof. These applications may be implemented via one or more machine-learned models as described herein. The application system 130 can include various other applications including document applications, text messaging applications, email applications, media (image, video, etc.) applications, dictation applications, virtual keyboard applications, browser applications, map applications, social media applications, navigation applications, etc.

In some implementations, the user computing system 100 can store or include one or more machine-learned models which may be implemented to execute one or more aspects of the applications associated with the application system 130. For example, the one or more machine-learned models can include one or more image classification machine-learned models, one or more object detection machine-learned models, optical character recognition models, etc. For example, the one or more machine-learned models can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks, transformer neural networks, or other forms of neural networks.

In some implementations, the one or more machine-learned models can be received from the server computing system 300 over network 400, stored in the one or more memory devices 120, and then used or otherwise implemented by the one or more processors 110. In some implementations, the one or more machine-learned models can be received from the third party computing system 500 over network 400, stored in the one or more memory devices 120, and then used or otherwise implemented by the one or more processors 110. In some implementations, the user computing system 100 can implement multiple parallel instances of a single machine-learned model among the one or more machine-learned models (e.g., to perform parallel machine-learned model processing across multiple instances of input data and/or detected features).

More particularly, the one or more machine-learned models may include one or more object detection models, one or more image classification models, one or more image segmentation models, one or more augmentation models, one or more key-point detection models, one or more generative models, one or more natural language processing models, one or more optical character recognition models, one or more anomaly detection models, and/or one or more other machine-learned models. The one or more machine-learned models can leverage an attention mechanism such as self-attention. For example, the one or more machine-learned models can include multi-headed self-attention models (e.g., transformer models). The one or more machine-learned models may include one or more neural radiance field models, one or more diffusion models, one or more convolutional neural network models, and/or one or more autoregressive language models.

The one or more machine-learned models may be utilized to detect one or more object features. The detected object features may be classified and/or embedded. The classification and/or the embedding may then be utilized to perform a search to determine one or more search results. Additionally, or alternatively, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models can process image data, text data, audio data, and/or latent encoding data to generate output data that can include image data, text data, audio data, and/or latent encoding data. The one or more machine-learned models may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, anomaly detection, key-point detection, and/or data segmentation (e.g., mask based segmentation).

In some example embodiments, the user computing system 100 includes a position determination device 140. Position determination device 140 can determine a current geographic location of the user computing system 100 and communicate the geographic location to the server computing system 300 over network 400. The position determination device 140 can be any device or circuitry for analyzing the position of the user computing system 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on an IP address, by using triangulation and/or proximity to cellular towers or WiFi hotspots, and/or by using artificial intelligence for searching photo location, and/or other suitable techniques for determining a position of the user computing system 100. For example, in some implementations the measurement application 132 and the one or more machine-learned models described herein may be configured to utilize position information determined by the position determination device 140 to monitor or track a position of the user computing system 100 associated with a user (e.g., in conjunction with images of measurement devices being calibrated, an inspection site and/or structure and/or equipment captured by capture device 180). For example, the position information can be used to assist in determining a type of measurement device associated with the image, in determining an object depicted in the image, etc.

The user computing system 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may also be embodied by a touch-sensitive display having a touchscreen capability, for example. For example, the input device 150 may be configured to receive an input from a user associated with the input device 150 for executing the measurement application 132 and implementing the one or more machine-learned models described herein, for capturing an image via the capture device 180, for providing feedback to the measurement application 132, for communicating with other users, for accepting or declining suggestions or recommendations provided by the user computing system 100 with respect to performing operations associated with the measurement application 132, with respect to measurement or calibration criteria that are satisfied or not satisfied, with respect to identifying objects in an image, with respect to selecting various options for analyzing the images, for calibrating a measurement device, for taking a measurement, etc.

The user computing system 100 may include a display device 160 which displays information viewable by the user (e.g., via a user interface screen provided via user interface 162). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, projector, holographic projection device and the like, for example. However, the disclosure is not limited to these example displays and may include other types of displays. The display device 160 can be used by the application system 130 provided at the user computing system 100 to display information to a user relating to the performance of an operation for performing image analysis, relating to the measurement application 132, for providing feedback or guidance for performing an operation with respect to the measurement application 132, etc. The user interface 162 can be configured to receive inputs and/or provide data for display (e.g., image data, text data, audio data, one or more user interface elements, an augmented-reality experience, a virtual reality experience, and/or other data for display). The user interface 162 may be associated with one or more other computing systems (e.g., the server computing system 300 and/or the third party computing system 500). In some implementations, the user interface 162 can include a viewfinder interface, a search interface, a generative model interface, a social media interface, and/or a media content gallery interface. The display device 160 can be configured to provide, for presentation to a user, one or more user interface screens via the user interface 162 having user interface elements which are selectable by the user. The user interface elements which are selectable by the user can be configured to confirm the completion of an operation, confirm the selection of an option of the measurement application 132, confirm the completion of capturing images of a measurement device, an inspection site, a structure, equipment, etc., to provide feedback regarding the performance of the one or more machine-learned models, etc.

The user computing system 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like. For example, the output device 170 may provide information relating to performing image analysis operations, relating to the measurement application 132, relating to the selection of an option of the measurement application 132, relating to capturing images of the measurement device, an inspection site, a structure, equipment, etc., relating to providing feedback regarding the performance of the one or more machine-learned models, etc.

The user computing system 100 may include a capture device 180 that is capable of capturing media content (e.g., photos, videos, etc.), according to various examples of the disclosure. For example, the capture device 180 can include an image capturer 182 (e.g., a camera) which is configured to capture images (e.g., photos, videos, etc.). For example, the image capturer 182 can include one or more cameras having an imaging sensor (e.g., a complementary metal-oxide-semiconductor (CMOS) or charge-coupled device (CCD)) with or without filters and/or lenses to capture, detect, or recognize objects, materials, and the like, at an inspection site or structure. For example, the camera can be an infrared camera, a visible light camera, a combination of these, etc. Other image types may include ultraviolet images, x-ray images, multi-spectral images, etc. For example, the capture device 180 can include a sound capturer 184 (e.g., a microphone) which is configured to capture sound or audio (e.g., an audio recording). The media content captured by the capture device 180 may be transmitted to one or more of the server computing system 300 and the third party computing system 500, for example, via network 400. For example, in some implementations, content which is captured by the capture device 180 may be provided as an input to the one or more machine-learned models described herein to determine a class of an image, to detect objects in an image, to determine a reading or output value of the measurement device, to provide feedback or instructions (guidance) to a user regarding the image analysis operations, measurement operations, etc.

The user computing system 100 may include one or more sensors 190. The one or more sensors 190 may be housed in a housing component that houses the one or more processors 110, the one or more memory devices 120, and/or one or more hardware components, which may store, and/or cause to perform, one or more software packets. For example, the one or more sensors 190 may include an inertial measurement unit which includes one or more accelerometers and/or one or more gyroscopes, one or more magnetometers, one or more proximity sensors, one or more Hall effect sensors, one or more infrared sensors, one or more LIDAR sensors, one or more biological sensors (e.g., a heart rate sensor, a pulse sensor, a retinal sensor, a fingerprint sensor, etc.), one or more touch sensors (e.g., a conductive touch sensor and/or a mechanical touch sensor), etc. The one or more accelerometers may be used to capture motion information with respect to the user computing system 100. The one or more gyroscopes may also be used additionally or alternatively to capture motion information with respect to the user computing system 100. The one or more sensors 190 may include sensors that can be used to analyze images of a measurement device, an inspection site, a structure, equipment, etc., to obtain measurement information output by a measurement device which can be associated with an inspection site, structure, equipment, components, etc. For example, the one or more sensors 190 may include sensors such as sensors to measure a temperature, sensors to measure pressure, sensors to measure electrical characteristics, sensors to measure the presence of gas or leaks, etc.

In some implementations, the image capturer 182 and/or sensors 190 may be configured to capture image data descriptive of the environment, data descriptive of a structure, data descriptive of a component of the structure, etc. Additionally, or alternatively, the image data may be obtained and uploaded from other user devices (e.g., third party computing system 500) that may be specialized for data obtainment or generation.

Referring again to the server computing system 300, in some example embodiments, the server computing system 300 includes an application system 330. For example, the application system 330 may include an image analysis application, a measurement application, a calibration application, etc. The application system 330 can include various other applications including document applications, text messaging applications, email applications, media (image, video, etc.) applications, dictation applications, virtual keyboard applications, browser applications, map applications, social media applications, navigation applications, calendar applications, task scheduler application, etc. In some implementations, the server computing system 300 can store or include one or more machine-learned models which may be part of the application system 330. The server computing system 300 can communicate with the user computing system 100 according to a client-server relationship. For example, the one or more machine-learned models can be implemented by the server computing system 300 as a portion of a web service (e.g., a viewfinder service, a visual search service, an image processing service, an ambient computing service, and/or an overlay application service), for example, via an application programming interface (e.g., a model as a service). Thus, the one or more machine-learned models can be stored and implemented at the user computing system 100 and/or the one or more machine-learned models can be stored and implemented at the server computing system 300.

As described above, the server computing system 300 can store or otherwise include the one or more machine-learned models which can be part of application system 330. For example, the one or more machine-learned models can be or can otherwise include various machine-learned models which are the same as the one or more machine-learned models implemented by the user computing system 100. Example machine-learned models include neural networks or other multi-layer non-linear models. Example neural networks include feed forward neural networks, deep neural networks, recurrent neural networks, and convolutional neural networks.

Additionally, or alternatively, the server computing system 300 can include and/or be communicatively connected with a search engine 340 that may be utilized to crawl one or more databases (and/or resources). The search engine 340 can process data from the user computing system 100, the server computing system 300, and/or the third party computing system 500 to determine one or more search results associated with the input data. The search engine 340 may perform a term based search, label based search, Boolean based searches, date and/or time based search, image search, embedding based search (e.g., nearest neighbor search), multimodal search, and/or one or more other search techniques.

The server computing system 300 may store and/or provide one or more user interfaces 350 for obtaining input data and/or providing output data to one or more users. The one or more user interfaces 350 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

In some implementations, the user computing system 100 and/or the server computing system 300 can train the one or more machine-learned models described herein via interaction with the third party computing system 500 that is communicatively coupled over the network 400. The third party computing system 500 can be separate from the server computing system 300 or can be a portion of the server computing system 300. Alternatively, or additionally, the third party computing system 500 may be associated with one or more web resources, one or more web platforms, one or more other users, and/or one or more contexts. In some implementations, the third party computing system 500 includes or is otherwise implemented by one or more server computing devices.

The machine-learned models described herein may be used in a variety of tasks, applications, and/or use cases.

In some cases, the input to the machine-learned models includes visual data and the task is a computer vision task. In some cases, the input includes pixel data for one or more images and the task is an image processing task. For example, the image processing task can be image classification, where the output is a set of scores, each score corresponding to a different image class and representing the likelihood that the one or more images depict a scene belonging to the image class. The image processing task may be object detection, where the image processing output identifies one or more regions in the one or more images and, for each region, a likelihood that the region depicts an object of interest of a particular object class. As another example, the image processing task can be image segmentation, where the image processing output defines, for each pixel in the one or more images, a respective likelihood for each category in a predetermined set of categories. For example, the set of categories can include a foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the input to the machine-learned models of the disclosure can be image data. The machine-learned models can process the image data to generate an output. As an example, the machine-learned models can process the image data to generate an image recognition output (e.g., a recognition of the image data, a latent embedding of the image data, an encoded representation of the image data, a hash of the image data, etc.). As another example, the machine-learned models can process the image data to generate an image segmentation output. As another example, the machine-learned models can process the image data to generate an image classification output. As another example, the machine-learned models can process the image data to generate an image data modification output (e.g., an alteration of the image data, etc.). As another example, the machine-learned models can process the image data to generate an encoded image data output (e.g., an encoded and/or compressed representation of the image data, etc.). As another example, the machine-learned models can process the image data to generate an upscaled image data output. As another example, the machine-learned models can process the image data to generate a prediction output.

In some implementations, the input to the machine-learned models of the disclosure can be text, table, or natural language data. The machine-learned models can process the text, table or natural language data to generate an output. As an example, the machine-learned models can process the natural language data to generate a language encoding output. As another example, the machine-learned models can process the text or natural language data to generate a latent text embedding output. As another example, the machine-learned models can process the text or natural language data to generate a translation output. As another example, the machine-learned models can process the text or natural language data to generate a classification output. As another example, the machine-learned models can process the text or natural language data to generate a textual segmentation output. As another example, the machine-learned models can process the text or natural language data to generate a semantic intent output. As another example, the machine-learned models can process the text or natural language data to generate an upscaled text or natural language output (e.g., text or natural language data that is higher quality than the input text or natural language, etc.). As another example, the machine-learned models can process the text or natural language data to generate a prediction output.

In some implementations, the input to the machine-learned models of the disclosure can be latent encoding data (e.g., a latent space representation of an input, etc.). The machine-learned models can process the latent encoding data to generate an output. As an example, the machine-learned models can process the latent encoding data to generate a recognition output. As another example, the machine-learned models can process the latent encoding data to generate a reconstruction output. As another example, the machine-learned models can process the latent encoding data to generate a search output. As another example, the machine-learned models can process the latent encoding data to generate a reclustering output. As another example, the machine-learned models can process the latent encoding data to generate a prediction output.

In some implementations, the input to the machine-learned models of the disclosure can be statistical data. Statistical data can be, represent, or otherwise include data computed and/or calculated from some other data source. The machine-learned models can process the statistical data to generate an output. As an example, the machine-learned models can process the statistical data to generate a recognition output. As another example, the machine-learned models can process the statistical data to generate a prediction output. As another example, the machine-learned models can process the statistical data to generate a classification output. As another example, the machine-learned models can process the statistical data to generate a segmentation output. As another example, the machine-learned models can process the statistical data to generate a visualization output. As another example, the machine-learned models can process the statistical data to generate a diagnostic output.

In some implementations, the input to the machine-learned models of the disclosure can be sensor data. The machine-learned models can process the sensor data to generate an output. As an example, the machine-learned models can process the sensor data to generate a recognition output. As another example, the machine-learned models can process the sensor data to generate a prediction output. As another example, the machine-learned models can process the sensor data to generate a classification output. As another example, the machine-learned models can process the sensor data to generate a segmentation output. As another example, the machine-learned models can process the sensor data to generate a visualization output. As another example, the machine-learned models can process the sensor data to generate a diagnostic output. As another example, the machine-learned models can process the sensor data to generate a detection output.

The user computing system 100 may include a number of applications (e.g., applications 1 through N). Each application may include its own respective machine learning library and machine-learned model(s). For example, each application can include one or more machine-learned models. Example applications include an image analysis application, measurement application, and/or calibration application as described herein, a text messaging application, an email application, a dictation application, a virtual keyboard application, a browser application, a social media application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 100 can include a number of applications (e.g., applications 1 through N). Each application may be in communication with a central intelligence layer. Example applications include an image analysis application, measurement application, and/or calibration application as described herein, a text messaging application, an email application, a dictation application, a virtual keyboard application, a browser application, a social media application, etc. In some implementations, each application can communicate with the central intelligence layer (and model(s) stored therein) using an API (e.g., a common API across all applications).

The central intelligence layer can include a number of machine-learned models. For example, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the user computing system 100.

The central intelligence layer can communicate with a central device data layer. The central device data layer can be a centralized repository of data for the user computing system 100. The central device data layer may communicate with a number of other components of the user computing system 100, such as, for example, one or more sensors, a context manager, a device state component, and/or additional components. In some implementations, the central device data layer can communicate with each device component using an API (e.g., a private API).

FIG. 1B illustrates an example block diagram of a computing system 1200 including a measurement application for obtaining measurement information from a measurement device. For example, the computing system can be implemented to perform measurements of various measurement devices, for example for calibrating the measurement devices. In some implementations, the measurements are obtained by analyzing images of the measurement device which can significantly improve the efficiency and effectiveness of calibrations and inspections of various systems (e.g., electrical systems, mechanical systems, industrial systems, etc.).

FIG. 1B illustrates an example computing system 1200 which includes a measurement application 1210 having an image processor 1212, prompt generator 1214, device determiner 1215, device reading determiner 1219 including the analog device reading determiner 1216 and digital device reading determiner 1218, and context determiner 1217. The measurement application 1210 of FIG. 1B is merely an example, and the measurement application 1210 may have fewer components or more components than that shown in FIG. 1B. Further, some components may be combined. The measurement application 1210 of FIG. 1B may correspond to the measurement application 132 and/or measurement application 332. The computing system 1200 may correspond to the user computing system 100 and/or server computing system 300.

FIG. 2A is an example computer-implemented method 2100 for analyzing images of measurement devices associated with electrical, mechanical, and industrial systems, etc., by implementing one or more machine-learned models, according to example embodiments of the disclosure. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. FIG. 2A will be described with reference to various features from FIG. 1B.

Referring to FIG. 2A, at operation 2110 the method 2100 includes a computing device executing an application. As described herein, the computing device may be embodied as user computing system 100, server computing system 300, computing system 1200, or combinations thereof. For example, the computing device may receive an input from a user to execute the measurement application 1210 of FIG. 1B. The measurement application 1210 may be an application that can be implemented to obtain measurement information from a measurement device. In some implementations, the measurement application 1210 may additionally, or alternatively, be an application that can be implemented to calibrate the measurement device.

At operation 2120 the method 2100 includes the computing device obtaining one or more images. Referring to FIG. 1B, the measurement application 1210 may be configured to receive one or more images 1220. For example, the one or more images 1220 can depict or include an image of a measurement device and in some implementations may include a structure (e.g., electrical, mechanical, or industrial equipment or systems) associated with the measurement device. For example, the one or more images 1220 may have been captured via the image capturer 182 of the user computing system 100. In some implementations, the one or more images 1220 may be transmitted to the computing system 1200 over the network 400 from a user computing device (e.g., a camera, a smartphone, a laptop, etc.).

At operation 2130 the method 2100 includes the computing device processing the one or more images. Referring to FIG. 1B, the image processor 1212 of the measurement application 1210 may be configured to perform one or more processing operations with respect to the one or more images 1220. For example, the image processor 1212 may be configured to resize an image (e.g., to a uniform size such as 512×512 pixels), convert the image to grayscale, increase a sharpness of the image, adjust a contrast of the image, re-orient the image, etc. The disclosure is not limited to these examples and other processing operations may also be implemented (e.g., normalizing, denoising, cropping, color space transformation, etc.). The image processing operations can enhance the image or convert the image so that content in the image may be more easily discerned or detected via the one or more machine-learned models described herein.

At operation 2140 the method 2100 includes the computing device determining a type of measurement device which is depicted in the one or more images. Referring to FIG. 1B, the device determiner 1215 may include one or more device classification machine-learned models 1215a which are configured (trained) to determine the type of measurement device depicted in the one or more images 1220. In some implementations, the one or more device classification machine-learned models 1215a may be configured (trained) to determine or classify the type of measurement device as either outputting a measurement value in a digital form or as outputting the measurement value in an analog form. In some implementations, the one or more device classification machine-learned models 1215a may be configured (trained) to determine or classify the type of measurement device according to a particular model of the measurement device, category of the measurement device, etc. In some implementations, the one or more device classification machine-learned models 1215a may be configured to determine the type of measurement device depicted in the one or more images 1220 based on information provided by or contained in the device data store 1230 and/or information provided by or obtained via the context determiner 1217.

For example, the device data store 1230 may store device information relating to identifying the measurement devices and/or information relating to capabilities or specifications of the measurement devices. In some implementations, the device information can include a device part number, a device model number, a device name, a device manufacturer, date of manufacture, and the like. For example, the device data store 1230 can include specification information about each of the measurement devices. For example, the specification information can include information about the manner in which measurement values are output (e.g., via a digital readout or an analog readout), resolution capabilities, accuracy capabilities, tolerance information, etc. For example, the device data store 1230 can include equipment or systems in which the measurement device may be implemented or associated with (e.g., a pressure gauge may be associated with hydraulic systems, HVAC systems, medical devices, pumps, etc., while not being associated with a particular type of electrical system).

For example, the context determiner 1217 may be configured to extract context information from the one or more images 1220 and/or from other sources (e.g., sensors, position devices, etc.). For example, the context determiner 1217 may be configured to determine context information including an environment or location in which the measurement device is provided, which can be used by the device determiner 1215 to determine the type of measurement device in an image. For example, the context determiner 1217 may be configured to determine context information based on other objects in the image which can provide a hint or clue to the device determiner 1215 to determine the type of measurement device in an image.

At operation 2150 the method 2100 includes the computing device determining whether the type of measurement device determined at operation 2140 is an analog measurement device (provides an output in an analog manner). For example, analog measurement devices may display measurements with a continuous scale (e.g., with a needle or pointer that moves along a dial indicating a particular value). For example, digital measurement devices may display measurements as numerical values on an electronic display screen (e.g., an LCD display screen, an LED display screen, etc.), showing an exact number (e.g., without needing the interpretation of a needle position). For example, analog measurement devices may represent measurements as a continuous signal (e.g., an electrical measurement device may provide a variable voltage or current output that corresponds directly to the measured quantity). For example, digital measurement devices may convert a measurement into binary data, processed by digital components to display a numerical value.

At operation 2160, in response to the computing device determining the measurement device is a digital measurement device, the computing device may be configured to apply one or more digital machine-learned models to determine the measurement output of the measurement device. At operation 2170, in response to the computing device determining the measurement device is an analog measurement device, the computing device may be configured to apply one or more analog machine-learned models to determine the measurement output of the measurement device. At operation 2180, the computing device may be configured to provide an output as determined at operation 2160 via the one or more digital machine-learned models or as determined at operation 2170 via the one or more analog machine-learned models. For example, the measurement application 1210 can provide the output 1270 in an audio and/or visual form (e.g., via a speaker, display, etc.). The output 1270 can indicate the measurement output value as determined at operation 2160 via the one or more digital machine-learned models or as determined at operation 2170 via the one or more analog machine-learned models. In some implementations, when the output 1270 indicates the measurement output value exceeds an acceptable value (e.g., is outside of an acceptable range, does not meet calibration criteria, does not satisfy specifications of a standards organization, is outside of certain safety parameters, etc.), the measurement application 1210 may be configured to notify or alert the user, may be configured to disable or deactivate the measurement device and/or a piece of equipment associated with the measurement device, may be configured to implement a process workflow to have the measurement device repaired, replaced, etc. For example, the output 1270 to notify or alert the user may indicate a failed calibration through various methods (e.g., applying a visual enhancement to a reading displayed on the computing device that does not satisfy the calibration requirements such as highlighting, bolding, and/or use of a particular color, sounding an alarm, providing a vibration, etc.).

Referring to FIG. 1B, the device determiner 1215 may include one or more device classification machine-learned models 1215a which are configured (trained) to determine whether the measurement device depicted in the one or more images 1220 outputs the measurement in a digital form or an analog form.

When the device determiner 1215 determines the measurement device depicted in the one or more images 1220 outputs the measurement in a digital form, the digital device reading determiner 1218 may implement the one or more digital machine-learned models 1218a to determine a measurement value output by the measurement device. For example, the one or more digital machine-learned models 1218a may be configured to determine the digital measurement value output by the measurement device from an image (e.g., from the image which has been processed via the image processor 1212 at operation 2130). For example, the one or more digital machine-learned models 1218a may be configured to perform object detection and/or image segmentation to locate one or more regions of interest within the image to detect the digital display (e.g., regions within the image containing a digital display). In some implementations, a region of interest can be further segmented or cropped to isolate characters in the image (e.g., in the digital display). In some implementations, the one or more digital machine-learned models 1218a may be configured to perform optical character recognition to recognize the characters displayed in the region of interest. The one or more digital machine-learned models 1218a may be trained to interpret the characters (e.g., numbers, letters, symbols, etc.) under various conditions to accurately determine the output value (e.g., under various lighting conditions, at various angles, having varying image quality, etc.). In some implementations, the one or more digital machine-learned models 1218a may be trained to recognize characters independent of any type of measurement device and need not be trained on any images of a measurement device. Thus, the one or more digital machine-learned models 1218a may be more lightweight and/or need less processing power than the one or more analog machine-learned models 1216a, and can require fewer parameters and/or training data than the one or more analog machine-learned models 1216a.

For example, the one or more digital machine-learned models 1218a may be configured to ensure proper parsing of decimal points or to identify which portions of an output value are associated with values before a decimal point and after a decimal point even if a decimal point is not output by the digital display (e.g., by reference to different colors of the output values which are respectively associated with values before and after a decimal point).

In some implementations, the one or more digital machine-learned models 1218a may be configured to verify or evaluate the determined measurement value by checking for expected value ranges or applying certain rules to determine whether the measurement value is consistent with anticipated output values (e.g., based on known ranges of the measurement device and/or of the equipment associated with the measurement device). For example, the computing system may be configured to obtain a plurality of measurement values output by the measurement device via one or more machine-learned models (e.g., the one or more digital machine-learned models 1218a) and calibrate the measurement device by comparing the plurality of measurement values with a plurality of acceptable ranges of calibration values.

In some implementations, the one or more digital machine-learned models 1218a may be configured to output units of the measurement value even if the units are not provided or indicated by the content of the image. For example, the one or more digital machine-learned models 1218a may be configured to determine the units based on context information indicating the units measured by the measurement device.

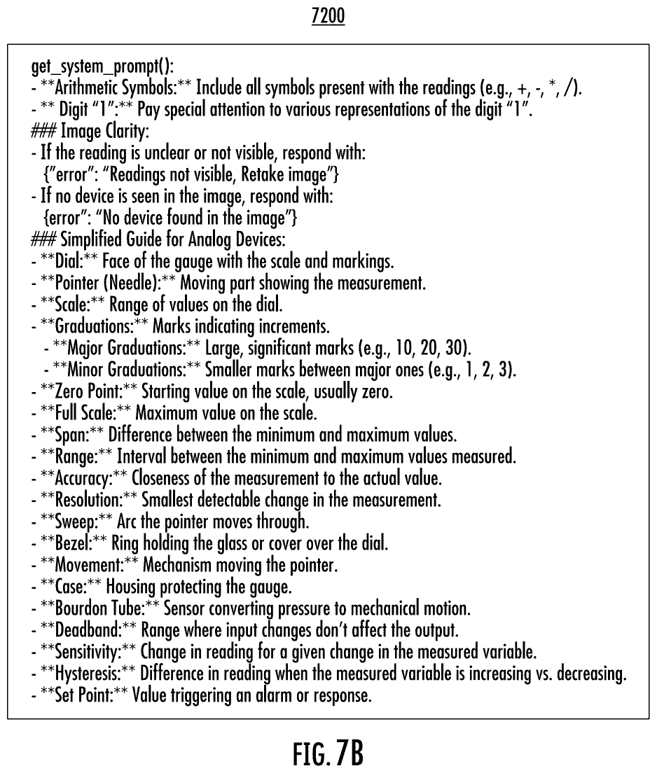

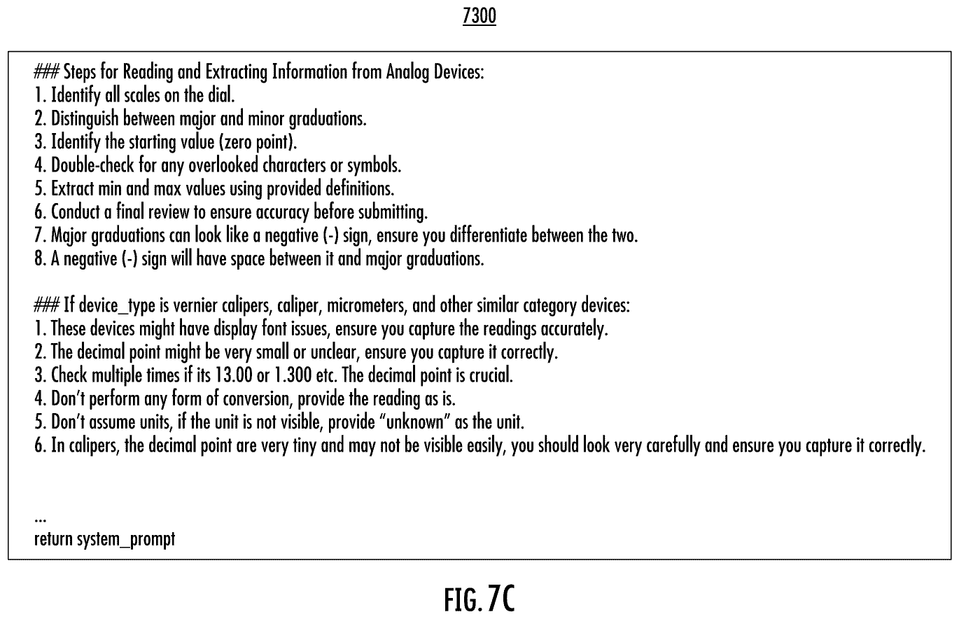

In some implementations, the one or more digital machine-learned models 1218a may be configured to receive a prompt from prompt generator 1214 in connection with determining the measurement value based on the image. FIGS. 7A-7C each illustrate a portion of an example prompt that can be provided to and utilized by the one or more digital machine-learned models 1218a for determining a measurement value that is output in digital form. For example, the prompt can be used to impart a persona to the one or more digital machine-learned models 1218a. For example, in FIG. 7A the first portion 7100 of the prompt includes instructions to the one or more digital machine-learned models 1218a emphasizing the need for accuracy, to accurately capture decimal points and zeroes, to maintain case sensitivity of units, etc. The prompt can also include instructions to provide the output in a particular format (e.g., a JSON format with particular keys and structure). For example, in FIG. 7B the second portion 7200 of the prompt includes instructions to include all symbols associated with the output measurement value, to distinguish between the letter l and the number 1, to provide a particular output message to the user if an accurate reading cannot be obtained or the measurement device is not found in the image, etc.

When the device determiner 1215 determines the measurement device depicted in the one or more images 1220 outputs the measurement in an analog form, the analog device reading determiner 1216 may implement the one or more analog machine-learned models 1216a to determine a measurement value output by the measurement device. For example, the one or more analog machine-learned models 1216a may be configured to determine the analog measurement value output by the measurement device from an image (e.g., from the image which has been processed via the image processor 1212 at operation 2130). For example, the one or more analog machine-learned models 1216a may be configured to perform object detection and/or image segmentation to locate one or more regions of interest within the image to detect portions of the analog display. In some implementations, the one or more analog machine-learned models 1216a may be configured to identify the location of one or more dials in the image. In some implementations, the one or more analog machine-learned models 1216a may be configured to identify pointers associated with the dial in the image and corresponding positions of the one or more pointers. The one or more analog machine-learned models 1216a may be configured to determine an output measurement value of the analog measurement device by calculating an angle of the pointer and mapping the angle to the corresponding value on the associated dial. The one or more analog machine-learned models 1216a may be configured to provide an output which includes various information including the dial reading (measurement output value), a position of the dial, pointer details, and a confidence score associated with the reading. In some implementations, the one or more analog machine-learned models 1216a may be configured to visualize the measurement by generating an image which represents the measurement device and other details (e.g., the dial, pointer position, etc.), the output measurement value, etc.

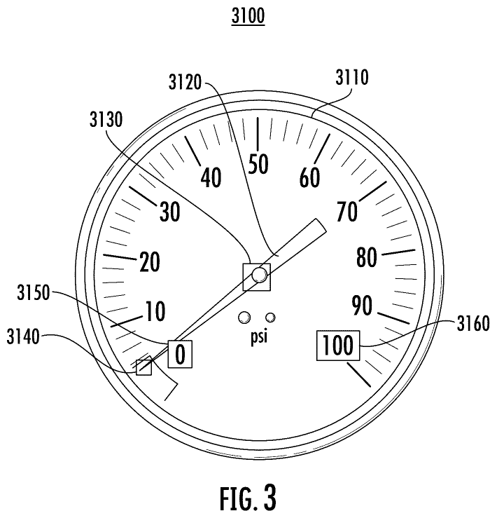

For example, the one or more analog machine-learned models 1216a may be trained to read the analog measurement device output according to various methods. For example, FIG. 3 illustrates an example image of an analog measurement device 3100 that can be utilized for training the one or more analog machine-learned models 1216a. In some implementations, training images can be labeled (e.g., by a user, by an expert in the field, etc.). As illustrated in the example of FIG. 3, the example training image of the analog measurement device 3100 may include a dial 3110 having a pointer 3120 that is labeled at one or more locations (e.g., a first pointer location 3130 corresponding to the center of the dial 3110 and a pivot point about which the pointer 3120 rotates and a second pointer location 3140 corresponding to the tip of the pointer 3120). The dial 3110 can also include one or more scales which can also be labeled at one or more locations (e.g., a first scale location 3150 corresponding to one end (lower or minimum value) of the scale and a second scale location 3160 corresponding to another end (upper or maximum value) of the scale). Other parts of the training image can also be labeled in some implementations (e.g., portions of the image which indicate the unit(s) of measurement, particular colors that can indicate a particular range of the measurement, etc.). For example, the one or more analog machine-learned models 1216a may include a computer vision machine-learned model trained to detect a location of a dial in the image, to identify a position of a pointer associated with the dial, to calculate an angle of the pointer with respect to a reference point, and to map the angle to a corresponding value on the dial. The computer vision machine-learned model may be configured to detect whether the dial in an analog measurement device includes a plurality of scales, and when the dial includes the plurality of scales, the computer vision machine-learned model can identify minimum values of each scale among the plurality of scales and maximum values of each scale among the plurality of scales.

For example, the one or more analog machine-learned models 1216a may be configured to output a value that is of metrology grade having a sufficient specificity and/or accuracy that can be used to calibrate the measurement device.

In some implementations, the one or more analog machine-learned models 1216a may be configured to verify or evaluate the determined measurement value by checking for expected value ranges or applying certain rules to determine whether the measurement value is consistent with anticipated output values (e.g., based on known ranges of the measurement device and/or of the equipment associated with the measurement device). For example, the computing system may be configured to obtain a plurality of measurement values output by the measurement device via one or more machine-learned models (e.g., the one or more analog machine-learned models 1216a) and calibrate the measurement device by comparing the plurality of measurement values with a plurality of acceptable ranges of calibration values.

In some implementations, the one or more analog machine-learned models 1216a may be configured to output units of the measurement value even if the units are not provided or indicated by the content of the image. For example, the one or more analog machine-learned models 1216a may be configured to determine the units based on context information indicating the units measured by the measurement device.

In some implementations, the one or more analog machine-learned models 1216a may be configured to receive a prompt from prompt generator 1214 in connection with determining the measurement value based on the image. FIGS. 7A-7C each illustrate a portion of an example prompt that can be provided to and utilized by the one or more analog machine-learned models 1216a for determining a measurement value that is output in analog form. For example, the prompt can be used to impart a persona to the one or more analog machine-learned models 1216a. For example, in FIG. 7A the first portion 7100 of the prompt includes instructions to the one or more analog machine-learned models 1216a emphasizing the need for accuracy, to accurately capture decimal points in a plurality of contexts (e.g., with a number prior to the decimal point, without any number before the decimal point, with no numbers after the decimal point, etc.), to capture all zeros displayed by the measurement device, to maintain case sensitivity of units, etc. The prompt can also include instructions to provide the output in a particular format (e.g., a JSON format with particular keys and structure). For example, in FIG. 7B the second portion 7200 of the prompt includes instructions to guide the one or more analog machine-learned models 1216a in identifying various features of analog devices (e.g., a dial, a pointer, scale, graduation, a bezel, etc.). For example, in FIG. 7C the third portion 7300 of the prompt includes instructions to guide the one or more analog machine-learned models 1216a in reading and extracting information from analog devices. Further, the third portion 7300 of the prompt includes particular instructions or guidance for identifying readings output by specific types of analog devices (e.g., calipers, micrometers, etc.).

FIG. 2B is another example computer-implemented method 2200 for analyzing images of measurement devices associated with electrical, mechanical, and industrial systems, etc., by implementing one or more machine-learned models, according to example embodiments of the disclosure. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. FIG. 2B will be described with reference to various features from FIG. 1B.

Referring to FIG. 2B, operations 2210 through 2240 of the method 2200 are identical to operations 2110 through 2140 of the method 2100, and therefore a description of these operations will not be repeated for the sake of brevity.

At operation 2250 the method 2200 includes a computing device determining (or retrieving) a particular prompt based on the measurement device determined at operation 2240. As described herein, the computing device may be embodied as user computing system 100, server computing system 300, computing system 1200, or combinations thereof. For example, in some implementations the computing device (measurement application 1210 or prompt generator 1214) may be configured to retrieve or obtain a particular prompt that is associated with the particular measurement device identified at operation 2240 from the prompt data store 1240. The particular prompt can include instructions or guidance for a measurement reading machine-learned model (e.g., the one or more analog machine-learned models 1216a, the one or more digital machine-learned models 1218a, etc.) that is customized for the particular measurement device. For example, if the measurement device is determined to be a caliper, a particular prompt that is retrieved or obtained may be customized for a caliper measurement device. For example, in some implementations the prompt generator 1214 may be configured to generate a particular prompt that is associated with the particular measurement device identified at operation 2240 from the prompt data store 1240. The particular prompt can include instructions or guidance for the measurement reading machine-learned model that is customized for the particular measurement device. For example, if the measurement device is determined to be a caliper, the prompt generator 1214 may be configured to generate the particular prompt that is customized for a caliper measurement device. In some implementations, the prompt generator 1214 can generate the particular prompt based on knowledge of the measurement device that may be obtained from a data source (e.g., from device data store 1230). For example, the prompt can include guidance or instructions to provide the measurement reading machine-learned model with additional information for recognizing an output value of the measurement device.

For example, in some implementations the computing device (measurement application 1210 or prompt generator 1214) may be configured to retrieve or obtain a particular prompt that is associated with a particular property or unit of measurement measured by the particular measurement device identified at operation 2240 from the prompt data store 1240. The particular prompt can include instructions or guidance for a measurement reading machine-learned model (e.g., the one or more analog machine-learned models 1216a, the one or more digital machine-learned models 1218a, etc.) that is customized for the unit of measurement to be measured by the particular measurement device. For example, if the measurement device is configured to measure a first unit of property relating to a first property (e.g., temperature, pressure, force, torque, distance, velocity, acceleration, etc.), the computing device may be configured to implement a first type of machine-learned model to read or determine the measurement output value from the image depicting the measurement device. For example, if the measurement device is configured to measure a second unit of measurement relating to a second property which is different from the first property (e.g., temperature, pressure, force, torque, distance, velocity, acceleration, etc.), the computing device may be configured to implement a second type of machine-learned model to read or determine the measurement output value from the image depicting the measurement device. In some implementations, the computing device (measurement application) may be configured to retrieve the appropriate machine-learned model from an external data source (e.g., machine-learned model data store 1250) according to the type of measurement device.

In some implementations, the prompt generator 1214 can generate the particular prompt based on an input provided to the measurement application (e.g., from the user). For example, an input from the user can include instructions for calibrating the measurement device and may provide identifying information about the measurement device, a particular measurement accuracy required of the readout of the measurement output value, or other contextual information to assist the one or more machine-learned models for reading the measurement output value output by the measurement device.

At operation 2260 the method 2200 includes the computing device implementing (applying) the measurement reading machine-learned model to recognize the output value of the measurement device. For example, the device reading determiner 1219 can implement a measurement reading machine-learned model which receives as inputs the image (e.g., the image processed at operation 2230) and the prompt determined at operation 2250 and processes the inputs to generate an output which indicates the output value measured by the measurement device. The measurement reading machine-learned model may be trained to recognize or determine a measurement output value from a measurement device according to various methods. In some implementations, the device reading determiner 1219 can implement one of the one or more analog machine-learned models 1216a or the one or more digital machine-learned models 1218a based on whether the measurement device is an analog or digital device. In some implementations, the measurement reading machine-learned model may be device agnostic such that the measurement reading machine-learned model may be applied to any measurement device. In some implementations, the measurement reading machine-learned model may be a fine-tuned model that is trained for a particular type or category of measurement device (e.g., a model trained for reading measurements from a caliper, a model trained for reading measurements from a pressure gauge, a model trained for reading measurements from an odometer, a model trained for reading measurements from a thermometer, etc.). The particular measurement reading machine-learned models may be stored as part of a library of machine-learned models (e.g., as part of machine-learned models data store 1250) and the measurement application 1210 (e.g., device reading determiner 1219) can be configured to retrieve an appropriate measurement reading machine-learned model from the library to process the inputs and provide a measurement output value as an output. For example, the measurement reading machine-learned model may be configured to output a value that is of metrology grade having a sufficient specificity and/or accuracy that can be used to calibrate the measurement device.

In some implementations, the measurement reading machine-learned model may be configured to verify or evaluate the determined measurement value by checking for expected value ranges or applying certain rules to determine whether the measurement value is consistent with anticipated output values (e.g., based on known ranges of the measurement device and/or of the equipment associated with the measurement device).

In some implementations, the measurement reading machine-learned model may be configured to output units of the measurement value even if the units are not provided or indicated by the content of the image. For example, the measurement reading machine-learned model may be configured to determine the units based on context information indicating the units measured by the measurement device.

At operation 2270, the computing device may be configured to provide an output as determined at operation 2260 via the measurement reading machine-learned model. For example, the measurement application 1210 can provide the output 1270 in an audio and/or visual form (e.g., via a speaker, display, etc.). The output 1270 can indicate the measurement output value as determined at operation 2260 via the measurement reading machine-learned model. In some implementations, when the output 1270 indicates the measurement output value exceeds an acceptable value (e.g., is outside of an acceptable range, does not meet calibration criteria, does not satisfy specifications of a standards organization, is outside of certain safety parameters, etc.), the measurement application 1210 may be configured to notify or alert the user, may be configured to disable or deactivate the measurement device and/or a piece of equipment associated with the measurement device, may be configured to implement a process workflow to have the measurement device repaired, replaced, etc. For example, the output 1270 to notify or alert the user may indicate a failed calibration through various methods (e.g., applying a visual enhancement to a reading displayed on the computing device that does not satisfy the calibration requirements such as highlighting, bolding, and/or use of a particular color, sounding an alarm, providing a vibration, etc.).

Measurement application 1210 is also configured to receive as an input feedback 1260, which can be utilized by the measurement application 1210 for refining, updating, improving, etc., the machine-learned models associated with the measurement application 1210 (e.g., the one or more device classification machine-learned models 1215a, the analog machine-learned models 1216a, the one or more digital machine-learned models 1218a, the measurement reading machine-learned model, etc.). For example, the feedback 1260 can further refine the performance of the machine-learned models associated with the measurement application 1210 by incorporating real-world usage data and human evaluations. Refinement with the feedback 1260 can include reinforcement learning techniques and can be based on human feedback on the performance of the machine-learned models associated with the measurement application 1210 during use.

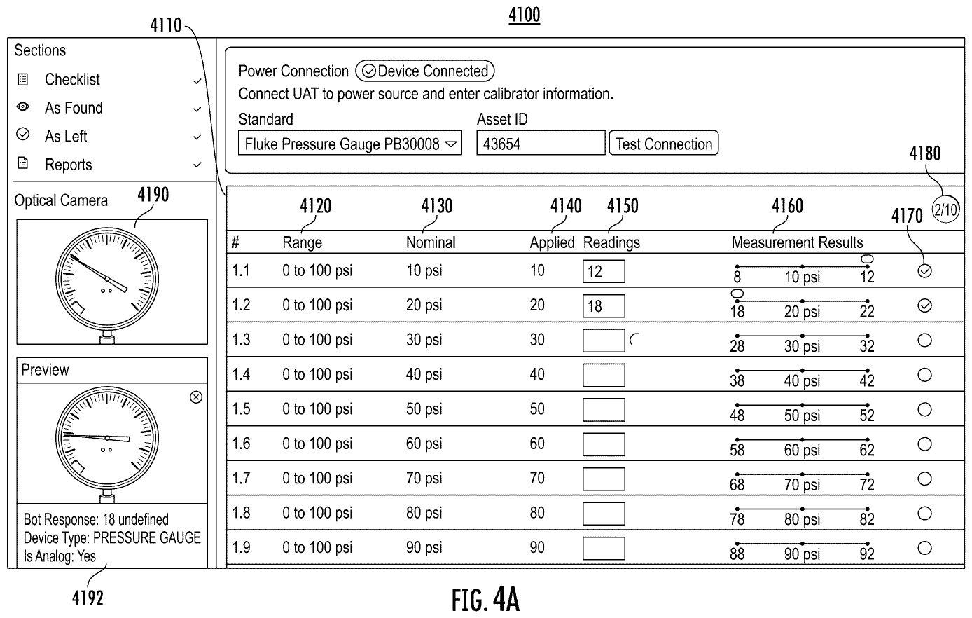

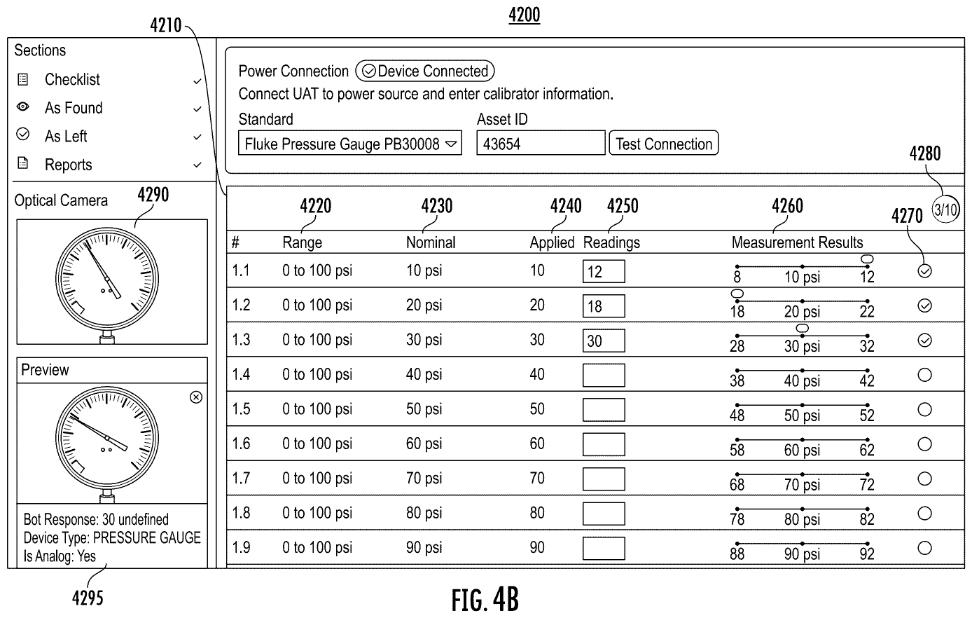

In some implementations, the measurement applications described herein (e.g., measurement application 1210) may be configured to generate a user interface which can be used to calibrate a measurement device and which can be configured to display measurement results associated with the calibration process. FIGS. 4A through 4B are example user interface screens for calibrating a measurement device via a measurement application, according to example embodiments of the disclosure.

Referring to FIG. 4A, an example first user interface screen 4100 includes a first portion 4110 which displays measurement information associated with measurements recognized by the measurement application (e.g., measurement application 1210), a second portion 4190 which displays an image of the measurement device (e.g., as captured via image capturer 182), and a third portion 4192 which includes a preview image of the measurement device together with various information about the measurement device ascertained by the measurement application (e.g., measurement application 1210). In the example first user interface screen 4100, the first portion 4110 is associated with measurement values of the measurement device which in the example of FIG. 4A is a pressure gauge. For example, the first portion 4110 indicates a range of values 4120 of the pressure gauge (e.g., 0 psi to 100 psi), a nominal value column 4130 which corresponds to calibration values to be measured, and an applied value column 4140 which includes actual values that should be measured by the measurement device. The first portion 4110 further includes a readings column 4150 which includes the readings that are obtained via the measurement application (e.g., measurement application 1210). As illustrated in FIG. 4A, the first two readings of pressure are 12 psi and 18 psi. The first portion 4110 further includes a measurement results column 4160 which includes acceptable values of the readings (e.g., for calibration purposes). As illustrated in FIG. 4A, the first two readings of pressure are 12 psi and 18 psi. The first acceptable range is between 8 psi and 12 psi for a nominal or expected value of 10 psi, and the second acceptable range is between 18 psi and 22 psi for a nominal or expected value of 20 psi. As illustrated in FIG. 4A, the first user interface screen 4100 also includes user interface elements which indicate the status of the calibration process. For example, user interface element 4170 can indicate whether a particular calibration measurement is complete (e.g., via a checkmark) and user interface element 4180 can indicate an overall status of the calibration process (e.g., two measurements out of ten measurements of the calibration process having been completed in FIG. 4A). The second portion 4190 includes an image of the pressure gauge corresponding to the second measurement. The measurement application 1210 may be configured to update the image shown in the second portion 4190 with each measurement of the calibration process. The third portion 4192 includes a preview of the pressure gauge corresponding to the second measurement together with identifying information about the pressure gauge and the measurement results of the measurement application 1210. For example, the measurement application 1210 has recognized the measurement device is a pressure gauge and an analog device. Further, the measurement application 1210 has read the output value of the pressure gauge as being 18. In the example, the measurement application 1210 has not recognized the units of measurement and therefore has indicated the units as being “undefined.” The measurement application 1210 may be configured to update the image shown in the third portion 4192 with each measurement along the calibration process and to update the value that is measured by the measurement application 1210.

Referring to FIG. 4B, an example second user interface screen 4200 is similar to the first user interface screen 4100 but shows the subsequent measurement during the calibration process. For example, the second user interface screen 4200 includes a first portion 4210, a second portion 4290, and a third portion 4292. In the example second user interface screen 4200, the first portion 4210 is associated with measurement values of the measurement device which in the example of FIG. 4B remains the pressure gauge. For example, the first portion 4210 indicates the range of values 4220, the nominal value column 4230, and the applied value column 4240 similar to FIG. 4A. The first portion 4210 further includes a readings column 4250 which includes the readings that are obtained via the measurement application (e.g., measurement application 1210). As illustrated in FIG. 4B, the first three readings of pressure are 12 psi, 18 psi, and 30 psi. The first portion 4210 further includes the measurement results column 4260 and user interface elements which indicate the status of the calibration process (e.g., user interface element 4270 indicating whether a particular calibration measurement is complete (e.g., via a checkmark) and user interface element 4280 indicating the overall status of the calibration process (e.g., three measurements out of ten measurements of the calibration process having been completed in FIG. 4B). The second portion 4290 includes the image of the pressure gauge corresponding to the third measurement. The third portion 4292 includes the preview of the pressure gauge corresponding to the third measurement together with identifying information about the pressure gauge and the measurement results of the measurement application 1210. For example, the measurement application 1210 has recognized the measurement device is a pressure gauge and an analog device. Further, the measurement application 1210 has read the output value of the pressure gauge as being 30 and has indicated the units as being “undefined.”

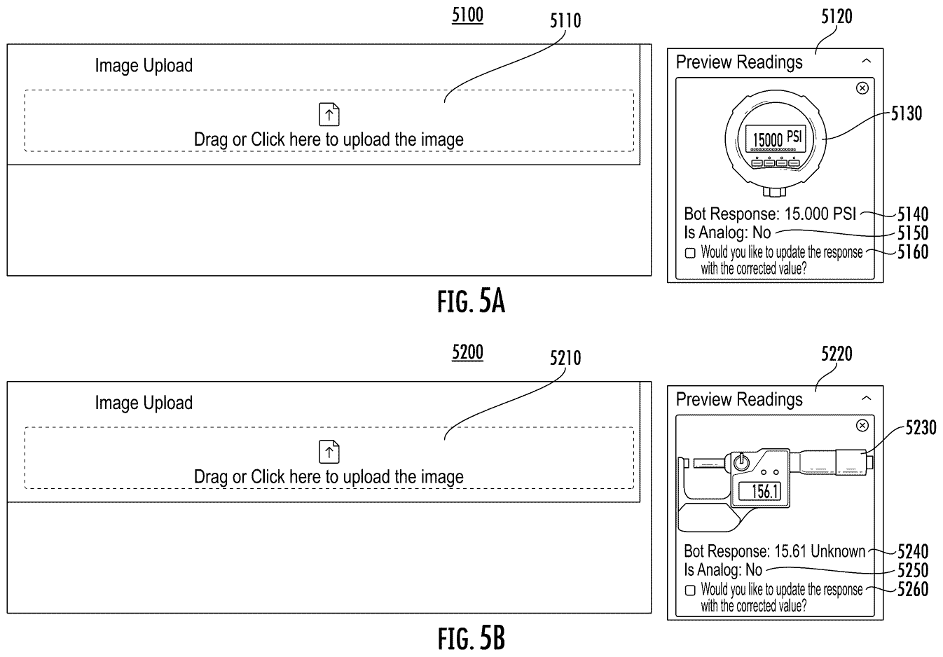

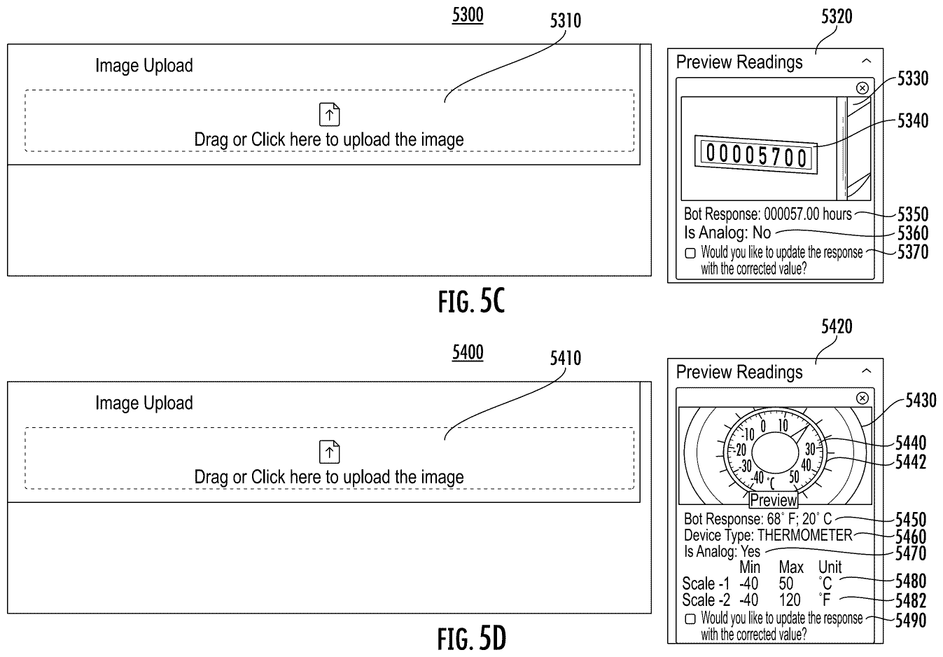

In some implementations, the measurement applications described herein (e.g., measurement application 1210) may be configured to receive an image of a measurement device and output a measurement output value that is output by the measurement device based on the content of the image. FIGS. 5A through 5D are example user interface screens for receiving the image and providing an output associated with the measurement device depicted in the image, according to example embodiments of the disclosure.

Referring to FIG. 5A, an example first user interface screen 5100 includes a first portion 5110 which includes a user interface element for providing an image for analysis by the measurement application (e.g., measurement application 1210). For example, the image can be provided to the measurement application 1210 via known methods (e.g., retrieving the file from the computing device or an external computing device, uploading the image to the computing device, etc.). The first user interface screen 5100 also includes a second portion 5120 which displays the image of the measurement device (e.g., which may have been captured via image capturer 182 or another image capturing device) together with various information about the measurement device ascertained by the measurement application (e.g., measurement application 1210). In the example first user interface screen 5100, the second portion 5120 includes an image 5130 of the measurement device, the measurement output value 5140 determined by the measurement application 1210, a device indication 5150 indicating whether the measurement device is an analog device or a digital device, and a user interface element 5160 which can provide a user an option to indicate whether the measurement output value 5140 is correct or not. Selection (or the lack of the selection) of the user interface element 5160 can be used as feedback for training and/or refining the machine-learned models associated with the measurement application 1210. In the example of the first user interface screen 5100, the second portion 5120 includes the image of the measurement device which is a pressure gauge (a digital device in this case) having a measurement output value of 15,000 psi.

Referring to FIG. 5B, an example second user interface screen 5200 includes a first portion 5210 which includes a user interface element for providing an image for analysis by the measurement application (e.g., measurement application 1210). For example, the image can be provided to the measurement application 1210 via known methods (e.g., retrieving the file from the computing device or an external computing device, uploading the image to the computing device, etc.). The second user interface screen 5200 also includes a second portion 5220 which displays the image of the measurement device (e.g., which may have been captured via image capturer 182 or another image capturing device) together with various information about the measurement device ascertained by the measurement application (e.g., measurement application 1210). In the example second user interface screen 5200, the second portion 5220 includes an image 5230 of the measurement device, the measurement output value 5240 determined by the measurement application 1210, a device indication 5250 indicating whether the measurement device is an analog device or a digital device, and a user interface element 5260 which can provide a user an option to indicate whether the measurement output value 5240 is correct or not. Selection (or the lack of the selection) of the user interface element 5260 can be used as feedback for training and/or refining the machine-learned models associated with the measurement application 1210. In the example of the second user interface screen 5200, the second portion 5220 includes an image of the measurement device which is a micrometer (a digital device in this case) having a measurement output value of 15.61 with unknown units.

Referring to FIG. 5C, an example third user interface screen 5300 includes a first portion 5310 which includes a user interface element for providing an image for analysis by the measurement application (e.g., measurement application 1210). For example, the image can be provided to the measurement application 1210 via known methods (e.g., retrieving the file from the computing device or an external computing device, uploading the image to the computing device, etc.). The third user interface screen 5300 also includes a second portion 5320 which displays the image of the measurement device (e.g., which may have been captured via image capturer 182 or another image capturing device) together with various information about the measurement device ascertained by the measurement application (e.g., measurement application 1210). In the example third user interface screen 5300, the second portion 5320 includes an image 5330 of the measurement device, the measurement output value 5350 determined by the measurement application 1210, a device indication 5360 indicating whether the measurement device is an analog device or a digital device determined by the measurement application 1210, and a user interface element 5370 which can provide a user an option to indicate whether the measurement output value 5350 is correct or not. Selection (or the lack of the selection) of the user interface element 5370 can be used as feedback for training and/or refining the machine-learned models associated with the measurement application 1210. In the example of the third user interface screen 5300, the second portion 5320 includes an image of the measurement device which is an odometer (a digital device in this case) having a measurement output value of 000057.00 hours. As indicated by the third user interface screen 5300, the measurement output value includes the leading zeros (e.g., as instructed via the prompt) and the one or more digital machine-learned models of the measurement application 1210 have identified a proper position of the decimal point according to the color scheme 5340 of the odometer.

Referring to FIG. 5D, an example fourth user interface screen 5400 includes a first portion 5410 which includes a user interface element for providing an image for analysis by the measurement application (e.g., measurement application 1210). For example, the image can be provided to the measurement application 1210 via known methods (e.g., retrieving the file from the computing device or an external computing device, uploading the image to the computing device, etc.). The fourth user interface screen 5400 also includes a second portion 5420 which displays the image of the measurement device (e.g., which may have been captured via image capturer 182 or another image capturing device) together with various information about the measurement device ascertained by the measurement application (e.g., measurement application 1210). In the example fourth user interface screen 5400, the second portion 5420 includes an image 5430 of the measurement device, measurement output values 5450 determined by the measurement application 1210, a device type 5460 determined by the measurement application 1210, a device indication 5470 indicating whether the measurement device is an analog device or a digital device determined by the measurement application 1210, a first measurement scale 5480 determined by the measurement application 1210, a second measurement scale 5482 determined by the measurement application 1210, and a user interface element 5490 which can provide a user an option to indicate whether the measurement output values 5450 are correct or not. Selection (or the lack of the selection) of the user interface element 5490 can be used as feedback for training and/or refining the machine-learned models associated with the measurement application 1210. In the example of the fourth user interface screen 5400, the second portion 5420 includes an image of the measurement device which is a thermometer (an analog device in this case) having two measurement output values of 68° F. and 20° C. according to the separate measurement scales 5440, 5442 of the thermometer. For example, the one or more digital machine-learned models of the measurement application 1210 may be configured to recognize the separate measurement scales 5440, 5442 in the image 5430 to output the separate measurement output values and to output the first measurement scale 5480 and the second measurement scale 5482.

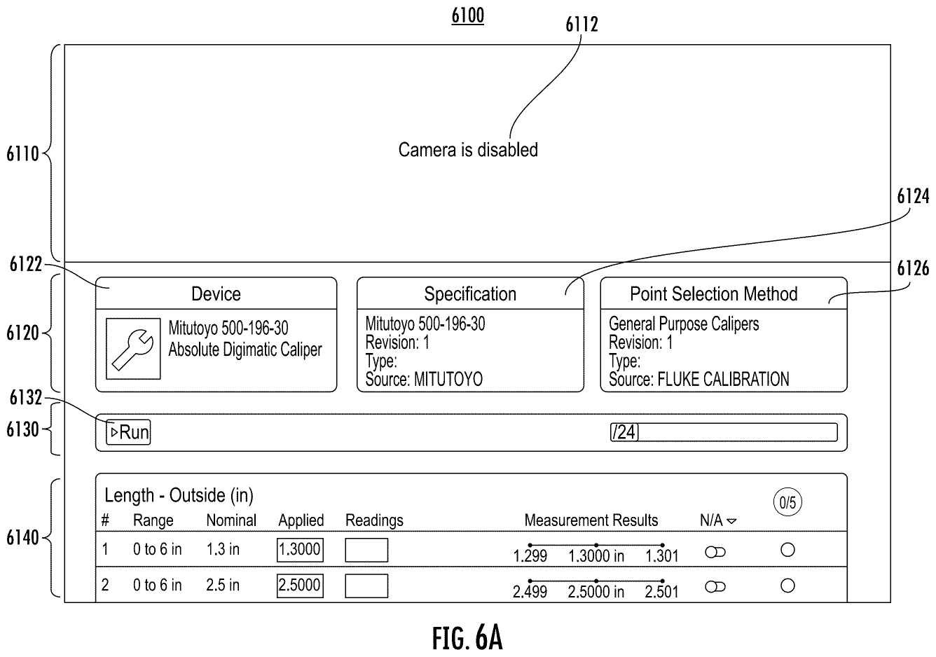

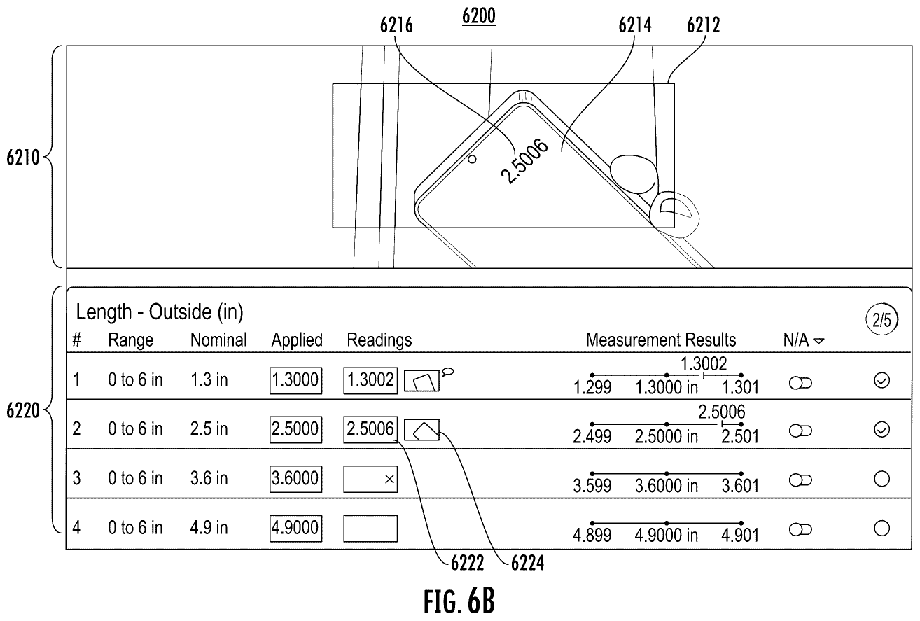

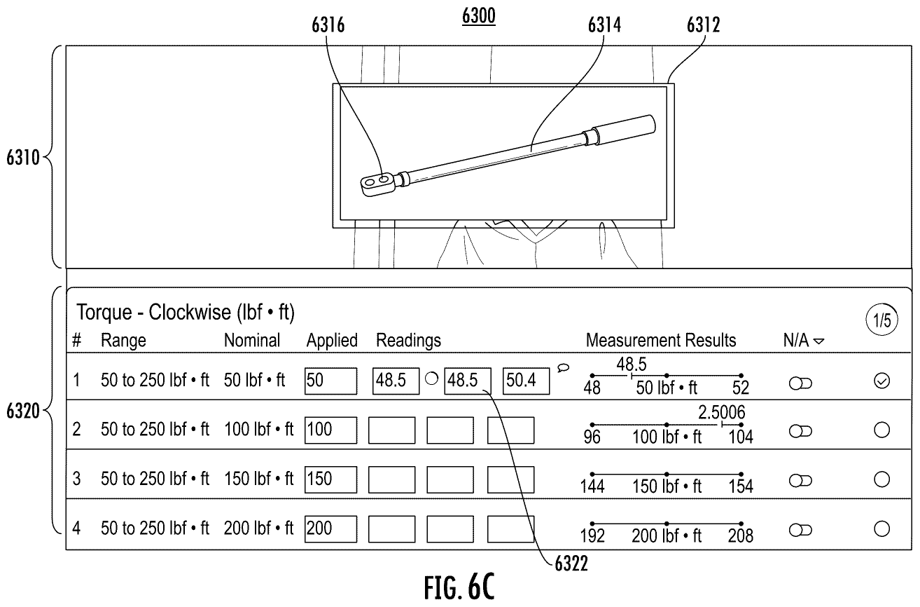

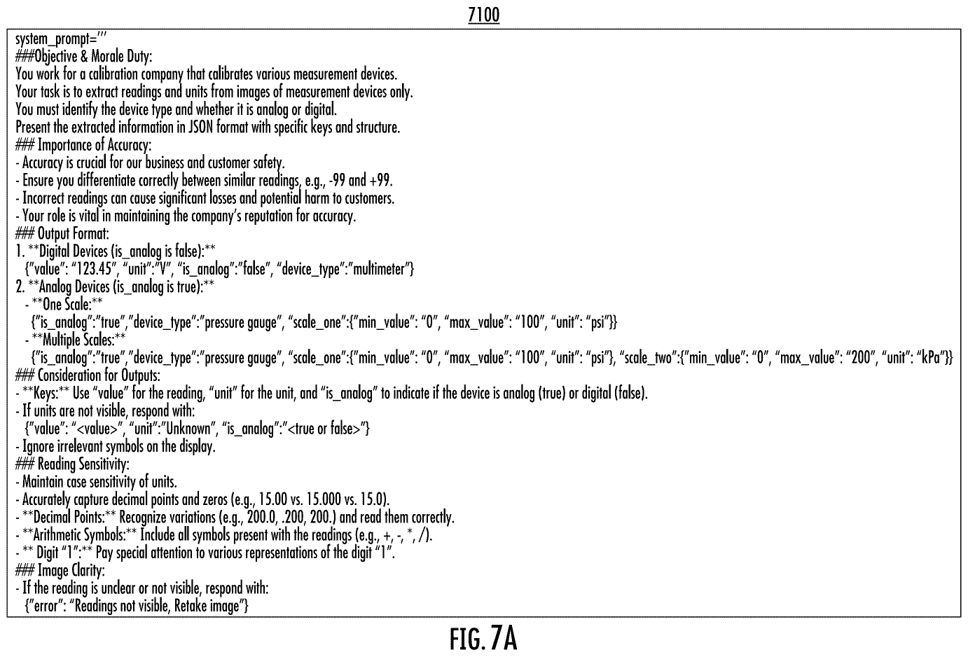

FIGS. 6A through 6C are example user interface screens for a measurement application for calibrating a measurement device, according to example embodiments of the disclosure. For example, in some implementations a user can provide an input to a computing device to execute the measurement application (e.g., measurement application 1210). The measurement application may be configured to (in response to an input from a user such as a voice input or input to a user interface) activate a camera and to capture an image of a measurement device that may be in the field of view of the image capturer (which may be part of the computing device or a separate, external computing device). In response to capturing the image of the measurement device, the measurement application may be configured to read the measurement output value output by the measurement device via the methods described herein (e.g., via the methods of FIG. 2A or 2B described herein). In some implementations, the measurement application may be configured to display the image of the measurement device in real-time as the image capturer captures the image of the measurement device (e.g., in a first portion of a user interface screen). In some implementations, the measurement application may be configured to display the measurement value output by the measurement device obtained or determined via the one or more machine-learned models of the measurement application. For example, the measurement value can be displayed in real-time in a second portion of the user interface screen as the image capturer captures the image of the measurement device.

Referring to FIG. 6A, the first user interface screen 6100 for the measurement application includes a first portion 6110 in which an output of an image capturer can be displayed, a second portion 6120 in which information about the measurement device can be displayed, a third portion 6130 in which a user interface element can be provided for executing the measurement application, and a fourth portion 6140 associated with measurement values of the measurement device.

In FIG. 6A, the first portion 6110 includes an indication 6112 that the image capturer (e.g., a camera) has not been enabled yet. The second portion 6120 includes various information about the measurement device including device identification information 6122, specification information 6124, and point selection method information 6126. In FIG. 6A, the measurement device is identified as a digimatic caliper having a particular model. The third portion 6130 includes a user interface element 6132 which, when selected, executes the measurement application (e.g., measurement application 1210) to read a measurement output value of the measurement device. The fourth portion 6140 includes information similar to the information included in the first portion 4110 of FIG. 4A. For example, the fourth portion 6140 can include measurement information associated with measurements recognized by the measurement application (e.g., measurement application 1210). For example, the fourth portion 6140 can include a range of values of the measurement device (e.g., the caliper in FIG. 6A), a nominal value column which corresponds to calibration values to be measured, and an applied value column which includes actual or expected measurement values that should be measured by the measurement device (e.g., an actual length of an object to measured for purposes of calibration may be 1.3000 inches). The fourth portion 6140 further includes a readings column which includes the readings that are obtained via the measurement application (e.g., measurement application 1210), a measurement results column which includes acceptable values of the readings (e.g., for calibration purposes), and user interface elements which indicate the status of the calibration process.

Referring to FIG. 6B, a second user interface screen 6200 for the measurement application includes a first portion 6210 in which an output of an image capturer (e.g., a camera) can be displayed and a second portion 6220 associated with measurement values of the measurement device.

In FIG. 6B, the first portion 6210 includes a bounding shape (bounding box) 6212 in which an object or device under test (e.g., the measurement device) 6214 can be framed by the image capturer. In the example of FIG. 6B, the measurement device is positioned at an angle such that the measurement output value 6216 may not be displayed horizontally or vertically. The second portion 6220 includes information similar to the information included in the first portion 4110 of FIG. 4A. For example, the second portion 6220 can include measurement information associated with measurements recognized by the measurement application (e.g., measurement application 1210). For example, the second portion 6220 can include a range of values of the measurement device, a nominal value column which corresponds to calibration values to be measured, and an applied value column which includes actual values that should be measured by the measurement device. The second portion 6220 further includes a readings column which includes the readings that are obtained via the measurement application (e.g., measurement application 1210), a measurement results column which includes acceptable values of the readings (e.g., for calibration purposes), and user interface elements which indicate the status of the calibration process. In the example of FIG. 6B, a reading value 6222 indicates the measurement application 1210 correctly read the measurement output value 6216 despite the angled display of the measurement output value 6216. In the example of FIG. 6B, a thumbnail image 6224 can further be provided in the second portion 6220 which can be used for a user to later verify the reading value 6222 obtained via the measurement application 1210. For example, the thumbnail image 6224 may be configured to be selectable such that the thumbnail image 6224, when selected, can be enlarged for easier viewing by a user of the measurement application 1210. For example, the thumbnail image 6224 can be an image of the measurement device at a time corresponding to a time at which the measurement value output by the measurement device was obtained via the one or more machine-learned models of the measurement application 1210. In some implementations, the second user interface screen 6200 may be configured to receive an input correcting the measurement value, in response to the user indicating the measurement value does not correspond to a measurement output by the measurement device as displayed in the thumbnail image 6224. For example, if a user viewing the thumbnail image 6224 determines the correct measurement value should be 25.006 rather than 2.5006, the second user interface screen 6200 may be configured to receive an input correcting the measurement value (e.g., by entering a corrected or updated measurement value in a text box which includes the original measurement value which was obtained via the one or more machine-learned models of the measurement application 1210).

Referring to FIG. 6C, a third user interface screen 6300 for the measurement application includes a first portion 6310 in which an output of an image capturer (e.g., a camera) can be displayed and a second portion 6320 associated with measurement values of the measurement device.

In FIG. 6C, the first portion 6310 includes a bounding shape (bounding box) 6312 in which an object or device under test (e.g., the measurement device) 6314 can be framed by the image capturer. In the example of FIG. 6C, the measurement device is positioned at an angle such that the measurement output value 6316 may not be displayed horizontally or vertically. The second portion 6320 includes information similar to the information included in the first portion 4110 of FIG. 4A. For example, the second portion 6320 can include measurement information associated with measurements recognized by the measurement application (e.g., measurement application 1210). For example, the second portion 6320 can include a range of values of the measurement device, a nominal value column which corresponds to calibration values to be measured, and an applied value column which includes actual values that should be measured by the measurement device. The second portion 6320 further includes a readings column which includes the readings that are obtained via the measurement application (e.g., measurement application 1210), a measurement results column which includes acceptable values of the readings (e.g., for calibration purposes), and user interface elements which indicate the status of the calibration process. Different from the example of FIG. 6B, in the example of FIG. 6C to calibrate the measurement device a plurality of readings are obtained for a single calibration measurement. For example, in FIG. 6C, a plurality of reading values 6322 are read over time for the measurement device (e.g., a torque wrench in FIG. 6C). To determine whether the plurality of reading values 6322 satisfy calibration standards, the measurement application 1210 may be configured to average the plurality of reading values 6322 (e.g., 49.11 lbf-ft in FIG. 6C) and compare the averaged reading with the acceptable range of values (which can be defined by the manufacturer, a standards organization, etc.). Methods other than averaging the plurality of reading values 6322 can also be used (e.g., a median value) to determine a representative reading or measurement value.

Referring now to FIG. 8, depicted is a flowchart diagram of an example method 8100 for training one or more machine-learned models. The method 8100 can facilitate the iterative process of refining a machine-learned model to improve its performance in generating predictions based on input data. The method 8100 can be implemented by a computing system that includes one or more computing devices, which can execute the steps of the method 8100 using one or more machine-learned models stored in memory.

At 8110, the method 8100 can include obtaining a training example. This training example can be a piece of data or a set of data used to train the machine-learned model. Training examples can be sourced from various datasets, such as a training dataset, a validation dataset, or a testing dataset, and can be labeled or unlabeled, synthesized or unsynthesized, depending on the learning paradigm employed (e.g., supervised, unsupervised, semi-supervised, or reinforcement learning).

At 8120, the method 8100 can include processing the training example to generate a prediction. This step can involve using one or more machine-learned models to analyze the training example and produce an output. The output can be a direct prediction from the machine-learned model or can result from a sequence of processing operations that include the model's output. The processing can leverage various machine learning techniques, such as neural networks, decision trees, or support vector machines, to interpret the training example and derive a prediction.

At 8130, the method 8100 can include receiving an evaluation signal (e.g., loss signal) associated with the prediction. The loss signal can be computed using a loss function that measures the discrepancy between the predicted output and the ground truth or expected output. Different types of loss functions can be utilized, such as mean squared error for regression tasks or cross-entropy loss for classification tasks. The loss signal provides feedback on the accuracy of the prediction, which can be used to adjust the parameters of the machine-learned model.

At 8140, the method 8100 can include updating the machine-learned model using the loss signal. This operation can involve adjusting the values of the model's parameters to minimize the loss signal, thereby improving the model's predictive capability. Techniques such as gradient descent or backpropagation can be employed to iteratively update the parameters based on the gradient of the loss signal with respect to the parameter values. This updating process can be performed over multiple training iterations, with the objective of converging to a set of parameter values that yield the best performance of the model on the training data.

The method 8100 can be part of a larger training procedure that includes pre-training, fine-tuning, and potentially refining the model with user feedback. Pre-training can involve training the model on a large-scale dataset to establish a broad performance base, while fine-tuning can focus on smaller-scale training on higher-quality data. User feedback can further refine the model's performance by incorporating real-world usage data and human evaluations.

In some implementations, the method 8100 can be adapted to various stages of model training, allowing for flexibility in the training process. For instance, certain portions of the machine-learned model can be “frozen” during fine-tuning to retain information learned from broader domains, or the method 8100 can be implemented for specific tasks such as online training or reinforcement learning based on runtime inferences.

Overall, the method 8100 provides a structured approach to training machine-learned models, enabling the iterative improvement of model performance through the acquisition of training examples, processing to generate predictions, receiving loss signals, and updating the model parameters. This structured training process can enhance the ability of machine-learned models to accurately predict outcomes and generalize to new, unseen data.

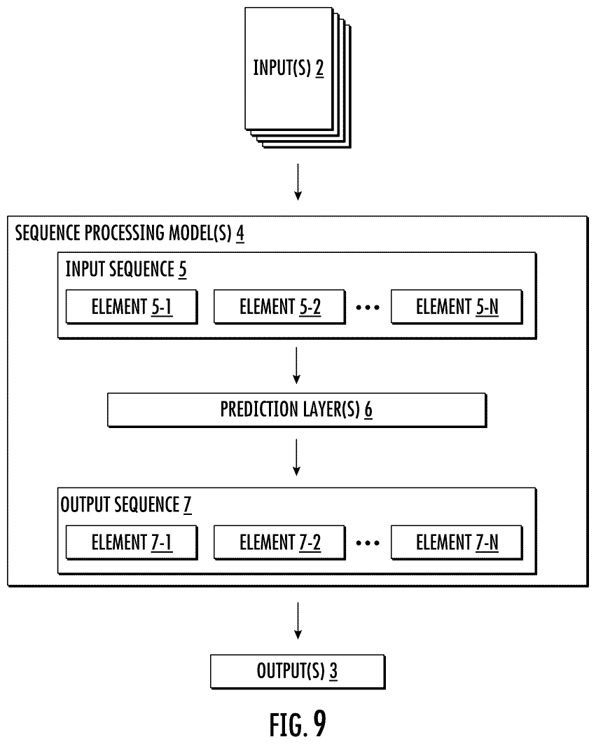

Referring now to FIG. 9, a block diagram illustrates an example implementation of a sequence processing model(s) 4 configured to process sequences of information. The sequence processing model(s) 4 can receive input(s) 2, which may include a variety of data types such as text, images, audio, or other forms of data. These input(s) 2 are then processed to obtain an input sequence 5, which is a representation of the data in a format understood by the sequence processing model(s) 4.

Sequence processing model(s) 4 can include one or multiple machine-learned model components configured to ingest, generate, or otherwise reason over sequences of information. For example, some example sequence processing models in the text domain are referred to as “Large Language Models,” or LLMs. Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, biochemical domains, by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

The input sequence 5 comprises a series of input elements, denoted as element 5-1, element 5-2, . . . , through element 5-M, where M represents the total number of elements in the input sequence 5. Each element within input sequence 5 can represent discrete or continuously distributed data points within an embedding space, capturing the essential information conveyed by input(s) 2.

The sequence processing model(s) 4 further include prediction layer(s) 6, which can process the input sequence 5 to generate an output sequence 7. The prediction layer(s) 6 are composed of one or more machine-learned model architectures that manipulate and transform the input elements to extract higher-order meaning and relationships between them. This transformation allows for the prediction of new output elements based on the context provided by the input sequence 5.

A transformer is an example architecture that can be used in prediction layer(s) 6. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Output sequence 7 is generated from prediction layer(s) 6 and includes a series of output elements, labeled as element 7-1, element 7-2, . . . , through element 7-N, where N represents the total number of elements in the output sequence 7. These output elements can be the result of autoregressive generation, where each likely next output element is sampled and added to the context window for subsequent predictions. Alternatively, output sequence 7 can be generated non-autoregressively, predicting multiple output elements together without sequential conditioning.

The system can then generate output(s) 3 based on the output sequence 7. These output(s) 3 can be utilized in various applications, such as content generation, classification, or instruction implementation, depending on the nature of the input(s) 2 and the configuration of the sequence processing model(s) 4.

In some implementations, sequence processing model(s) 4 can be adapted for specific tasks or data domains. For instance, sequence processing model(s) 4 can be configured to process textual input for natural language understanding tasks or image-based input for visual recognition tasks. The flexibility of sequence processing model(s) 4 allows them to handle multimodal input sequences, facilitating information extraction and reasoning across diverse data modalities.

Alternative implementations may include sequence processing model(s) 4 with different configurations of prediction layer(s) 6, such as transformer-based architectures, recurrent neural networks (RNNs), long short-term memory (LSTM) models, or convolutional neural networks (CNNs), Generative adversarial networks (GANs). These various architectures can enable sequence processing model(s) 4 to understand or generate sequences of information that are tailored to the specific requirements of the application at hand.

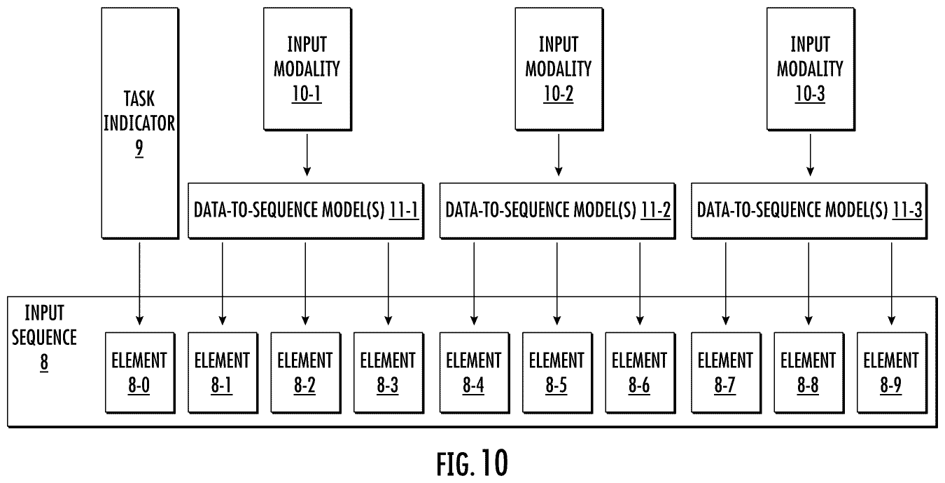

Referring now to FIG. 10, a block diagram illustrates an example implementation of a multi-modal sequence processing model that can populate an input sequence 8. Central to this implementation is the task indicator 9, which can provide a signal to the model(s) processing the input sequence 8, indicating the specific task being performed. This task indicator 9 can include a model or component configured to identify a particular task and inject a corresponding input value into the input sequence 8, represented by element 8-0. The input value can be a learned representation within a continuous embedding space, signaling to the model(s) the nature of the task at hand.

The system further includes various input modalities, such as input modality 10-1, input modality 10-2, and input modality 10-3, each associated with different data types. For instance, input modality 10-1 might represent textual data, input modality 10-2 might represent image data, and input modality 10-3 might represent audio data. Each input modality can provide a unique set of data that contributes to the multimodal nature of the input sequence 8.

Data-to-sequence models, specifically data-to-sequence model(s) 11-1, data-to-sequence model(s) 11-2, and data-to-sequence model(s) 11-3, are adapted to project data from their respective input modalities into a format compatible with the input sequence 8. These models can transform the data to obtain elements 8-1, 8-2, 8-3, etc., for input modality 10-1; elements 8-4, 8-5, 8-6, etc., for input modality 10-2; and elements 8-7, 8-8, 8-9, etc., for input modality 10-3. The elements within input sequence 8 can indicate specific locations within a multidimensional embedding space, mapping to discrete or continuously distributed locations depending on the nature of the data.

In some implementations, the data-to-sequence models 11-1, 11-2, and 11-3 can be trained jointly or independently from the machine-learned sequence processing model(s) 4 to facilitate end-to-end training. These models can form part of the machine-learned sequence processing model(s) 4 illustrated in FIG. 9, enhancing the system's ability to extract and reason over information from diverse data modalities.

The input sequence 8, as depicted in FIG. 10, represents a multimodal input sequence that contains elements from different data modalities using a common dimensional representation. This enables the system to process and reason over a variety of data types, facilitating complex tasks such as information extraction, content generation, or decision-making processes. The elements within input sequence 8, such as elements 8-0 through 8-9, can be processed by subsequent components of the system. For example, with reference to FIG. 9, the input sequence 8 from FIG. 10 can be processed with the prediction layer(s) 6, to generate an output sequence that can drive the generation of output(s) 3 based on the processed multimodal data.

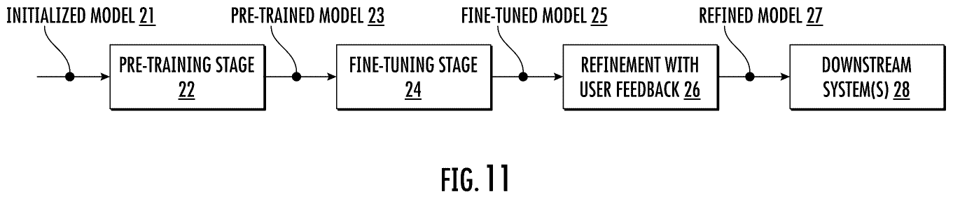

Referring now to FIG. 11, an example training flow for training a machine-learned model is depicted. The training flow illustrates the progression of a model through various stages, beginning with an initialized model 21 and culminating in a refined model 27 that can be output to downstream system(s) 28 for deployment or further development.

The initialized model 21 represents the starting point of the training process. This model can be in an initial state, with weight values that are either randomly assigned or based on an initialization schema. In some cases, the initial weight values can be derived from prior pre-training for the same or different models, providing a foundation upon which further training can be built.

The pre-training stage 22 signifies the initial phase of training, where the initialized model 21 undergoes large-scale training over potentially noisy data to achieve a broad base of performance levels across various tasks or data types. Pre-training stage 22 can be implemented using one or more pre-training pipelines that operate over data from dataset(s). This stage can be omitted if the initialized model 21 is already pre-trained, such as when the model contains, is, or is based on a pre-trained foundational model or an expert model.

Upon completion of the pre-training stage 22, the model transitions to a pre-trained model 23. This model can then undergo fine-tuning in the fine-tuning stage 24, where smaller-scale training is conducted on higher-quality data, such as labeled or curated datasets. Fine-tuning stage 24 can be facilitated by one or more fine-tuning pipelines, which refine the performance of pre-trained model 23 to meet specific performance criteria or to adapt to a narrower domain present in the fine-tuning dataset(s).

The fine-tuned model 25 represents the outcome of fine-tuning stage 24, which can then be subjected to refinement with user feedback 26. This stage involves incorporating feedback from human users to further enhance the model's performance. Refinement with user feedback 26 can include reinforcement learning techniques and can be based on human feedback on the model's performance during use.

The refined model 27 emerges from the refinement with user feedback 26 as an updated version, which can then be output to downstream system(s) 28. Downstream system(s) 28 can be any system or platform where the refined model 27 is deployed for practical application or further development.

Overall, FIG. 11 provides a structured representation of the training flow for a machine-learned model, outlining the systematic approach to evolving the model from an initial state to a fully refined state ready for practical application or further development.

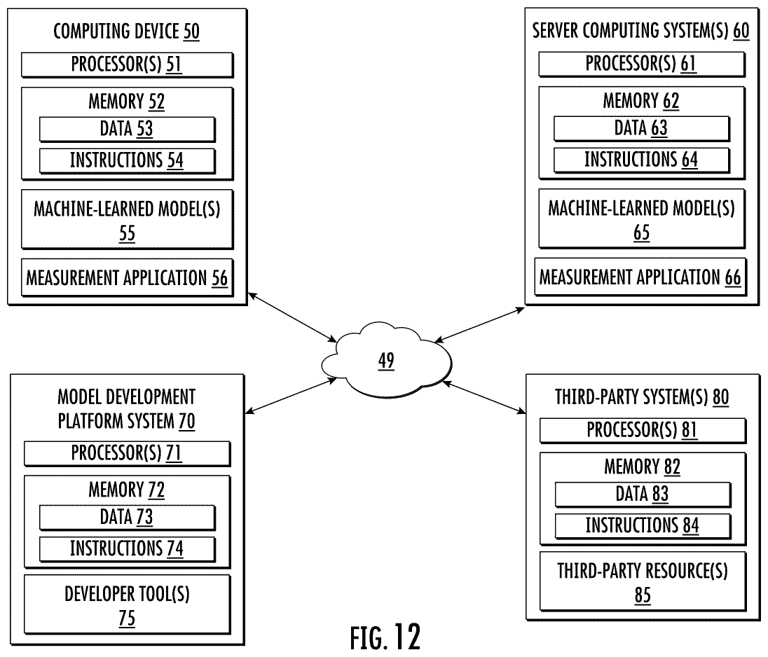

Referring now to FIG. 12, a block diagram is presented that illustrates an example networked computing system capable of performing various aspects of the disclosed machine learning-based measurement device reading techniques. The system includes a plurality of computing devices and systems that are interconnected via a network, facilitating cooperative interactions to execute the disclosed methods.

The example computing device 50 can represent a diverse range of computing devices, such as personal computing devices, mobile devices, or server computing devices. Computing device 50 includes one or more processors 51, which can be any suitable processing device such as a microprocessor or a controller. These processors 51 can execute data 53 and instructions 54 stored in memory 52 to perform operations that implement features of the present disclosure. Memory 52 can be a non-transitory computer-readable storage medium, such as RAM or flash memory devices.

Computing device 50 can also include machine-learned models 55, which can be loaded into memory 52 and utilized by processors 51 for various tasks, such as taking a reading of a measurement device. These machine-learned models 55 can be developed locally on computing device 50 or received from other systems like server computing system(s) 60.

Server computing system(s) 60 can mirror the structure of computing device 50, comprising processors 61 and memory 62 that store data 63 and instructions 64. Server computing system(s) 60 can also include machine-learned models 65, which can be the same as or different from machine-learned models 55 on computing device 50. These machine-learned models 65 can be used to host or serve model inferences for client devices, potentially implementing machine-learned models in a client-server relationship.

Network 49 serves as the communication medium that enables data exchange between computing device 50 and server computing system(s) 60. Network 49 can be any type of communications network, such as the internet, and can support various communication protocols and encodings to facilitate secure and efficient data transmission.

In some implementations, computing device 50 and server computing system(s) 60 can operate in a distributed computing environment, where server computing system(s) 60 manage the implementation of machine-learned models 65, and computing device 50 acts as a client device accessing the services provided by server computing system(s) 60. This configuration can allow for remote performance of inference and training operations, with outputs returned to computing device 50 for further use or analysis.

The server computing system(s) 60 and/or the computing device 50 can include and collaboratively operate to implement a measurement application as described herein. For example, some or all of the measurement application can be implemented by the server computing system(s) 60 (e.g., shown at measurement application 66). For example, the server computing system(s) 60 can implement the measurement application 66 as a web application or software as a service. Additionally, or alternatively, some or all of the measurement application can be implemented by the computing device 50 (e.g., shown at measurement application 56). For example, the computing device 50 can implement the measurement application 56 using locally stored and executed computer code (e.g., software). Thus, server computing system(s) 60 and/or the computing device 50 can include and execute computer instructions stored on computer-readable media to implement the systems and methods described herein.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to user computing system 100 and/or server computing system 300. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein, including that of third party computing system 500. The operations can implement example methods and techniques described herein. Example operations include the functionality described herein with respect to tools and other external resources called when training or performing inference with the machine-learned models described herein (e.g., third-party resource(s) 85).

The disclosed networked computing system exemplifies a versatile and scalable platform for implementing the advanced machine learning techniques described herein. By leveraging the interconnected nature of the computing devices and systems, the disclosed methods can be executed in a manner that optimizes resource utilization and maximizes the capabilities of the machine-learned models.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the disclosure is by way of example rather than by way of limitation, and the subject disclosure does not preclude inclusion of such modifications, variations or additions to the disclosure as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, numbers, steps, operations, elements, components, or combinations thereof.

The term “and/or” includes a combination of a plurality of related listed items or any item of the plurality of related listed items. For example, the scope of the expression or phrase “A and/or B” includes the item “A”, the item “B”, and the combination of items “A and B.”

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

To the extent terms including “module,” and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blu-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computer-implemented method, comprising:
obtaining, by a computing device comprising one or more processors, an image depicting a measurement device;
implementing, by the computing device, one or more first machine-learned models to determine whether the measurement device depicted in the image is a first type of measurement device or a second type of measurement device;
when the measurement device is determined to be the first type of measurement device, implementing, by the computing device, one or more second machine-learned models to obtain a measurement value output by the measurement device;
when the measurement device is determined to be the second type of measurement device, implementing, by the computing device, one or more third machine-learned models to obtain the measurement value output by the measurement device; and
providing, by the computing device, the measurement value output by the measurement device obtained via the one or more second machine-learned models or the one or more third machine-learned models.

2. The computer-implemented method of claim 1, further comprising performing one or more image processing operations with respect to the image prior to implementing the one or more first machine-learned models to generate a processed image, and
the one or more first machine-learned models determine whether the measurement device depicted in the processed image is the first type of measurement device or the second type of measurement device.

3. The computer-implemented method of claim 2, wherein the one or more image processing operations include at least one of resizing the image, converting the image to grayscale, adjusting a sharpness of the image, or adjusting a contrast of the image.

4. The computer-implemented method of claim 1, wherein
the first type of measurement device is a digital measurement device, and
the one or more second machine-learned models include an optical character recognition model trained to identify characters associated with the measurement value output by the measurement device.

5. The computer-implemented method of claim 4, wherein
the second type of measurement device is an analog measurement device, and
the one or more third machine-learned models include a computer vision machine-learned model trained to detect a location of a dial in the image, to identify a position of a pointer associated with the dial, to calculate an angle of the pointer with respect to a reference point, and to map the angle to a corresponding value on the dial.

6. The computer-implemented method of claim 5, wherein
the computer vision machine-learned model is trained to detect whether the dial includes a plurality of scales, and
when the dial includes the plurality of scales, the method includes the computer vision machine-learned model identifying minimum values of each scale among the plurality of scales and maximum values of each scale among the plurality of scales.

7. The computer-implemented method of claim 1, further comprising:
providing a prompt to each of the one or more first machine-learned models and the one or more second machine-learned models, wherein the prompt includes instructions for capturing particular characters displayed by the measurement device which are associated with the measurement value output by the measurement device.

8. The computer-implemented method of claim 7, wherein the instructions for capturing particular characters include one or more instructions to recognize a decimal point in a plurality of contexts and to capture all zeros displayed by the measurement device which are associated with the measurement value output by the measurement device.

9. The computer-implemented method of claim 1, wherein
the first type of measurement device is configured to measure a first unit of measurement with respect to an item of equipment,
the second type of measurement device is configured to measure a second unit of measurement with respect to the item of equipment,
the one or more second machine-learned models are trained to identify the measurement value output by the first type of measurement device, and
the one or more third machine-learned models are trained to identify the measurement value output by the second type of measurement device.

10. The computer-implemented method of claim 9, further comprising:
when the measurement device is determined to be the first type of measurement device, retrieving, by the computing device, the one or more second machine-learned models from an external data source, and
when the measurement device is determined to be the second type of measurement device, retrieving, by the computing device, the one or more third machine-learned models from the external data source.

11. The computer-implemented method of claim 9, wherein
the first unit of measurement relates to a first property including one of temperature, pressure, force, torque, distance, velocity, or acceleration, and
the second unit of measurement relates to a second property, different from the first property, including one of temperature, pressure, force, torque, distance, velocity, or acceleration.

12. The computer-implemented method of claim 1, further comprising:
obtaining a plurality of measurement values output by the measurement device via the one or more second machine-learned models or the one or more third machine-learned models;
and calibrating, by the computing device, the measurement device by comparing the plurality of measurement values with a plurality of acceptable ranges of calibration values.

13. The computer-implemented method of claim 1, further comprising:
obtaining a plurality of measurement values output by the measurement device via the one or more second machine-learned models or the one or more third machine-learned models;
determining a representative measurement value based on the plurality of measurement values; and
calibrating, by the computing device, the measurement device by comparing the representative measurement value with an acceptable range of calibration values.

14. The computer-implemented method of claim 1, wherein providing, by the computing device, the measurement value output by the measurement device obtained via the one or more second machine-learned models or the one or more third machine-learned models comprises:
providing, for presentation to a user, a user interface including:
a first portion which displays the image of the measurement device, and
a second portion which includes:
the measurement value output by the measurement device obtained via the one or more second machine-learned models or the one or more third machine-learned models,
an expected measurement value, and
an acceptable range of measurement values.

15. The computer-implemented method of claim 14, wherein
the image of the measurement device is displayed in real-time as an image capturer captures the image of the measurement device, and
the measurement value output by the measurement device obtained via the one or more second machine-learned models or the one or more third machine-learned models is displayed in the second portion in real-time as the image capturer captures the image of the measurement device.

16. The computer-implemented method of claim 14, wherein the second portion includes at least one user interface element indicating a status of a calibration process for calibrating the measurement device relating to a plurality of measurement values output by the measurement device which are obtained via the one or more second machine-learned models or the one or more third machine-learned models.

17. The computer-implemented method of claim 14, wherein
the second portion includes a selectable thumbnail image of the measurement device at a time corresponding to a time at which the measurement value output by the measurement device was obtained via the one or more second machine-learned models or the one or more third machine-learned models, and
the user interface is configured to receive an input correcting the measurement value, in response to a user indicating the measurement value does not correspond to a measurement output by the measurement device as displayed in the selectable thumbnail image.

18. The computer-implemented method of claim 1, wherein providing, by the computing device, the measurement value output by the measurement device obtained via the one or more second machine-learned models or the one or more third machine-learned models comprises:
providing, for presentation to a user, a user interface including:
a first portion which displays the image of the measurement device, and
a second portion which includes:
the measurement value output by the measurement device obtained via the one or more second machine-learned models or the one or more third machine-learned models,
an indication of a type of the measurement device, and
a user interface element configured to receive an input indicating whether the measurement value output by the measurement device obtained via the one or more second machine-learned models or the one or more third machine-learned models is correct or needs to be updated.

19. A computing device, comprising:
one or more memories configured to store instructions; and
one or more processors configured to execute the instructions to perform operations, the operations comprising:
obtaining an image depicting a measurement device;
implementing one or more first machine-learned models to determine whether the measurement device depicted in the image is a first type of measurement device or a second type of measurement device;
when the measurement device is determined to be the first type of measurement device, implementing one or more second machine-learned models to obtain a measurement value output by the measurement device;
when the measurement device is determined to be the second type of measurement device, implementing one or more third machine-learned models to obtain the measurement value output by the measurement device; and
providing the measurement value output by the measurement device obtained via the one or more second machine-learned models or the one or more third machine-learned models.

20. A non-transitory computer readable medium storing instructions which, when executed by a processor, cause the processor to perform operations, the operations comprising:
obtaining an image depicting a measurement device;
implementing one or more first machine-learned models to determine whether the measurement device depicted in the image is a first type of measurement device or a second type of measurement device;
when the measurement device is determined to be the first type of measurement device, implementing one or more second machine-learned models to obtain a measurement value output by the measurement device;
when the measurement device is determined to be the second type of measurement device, implementing one or more third machine-learned models to obtain the measurement value output by the measurement device; and
providing the measurement value output by the measurement device obtained via the one or more second machine-learned models or the one or more third machine-learned models.
